(19) United States
(12) Patent Application Publication
(10) Pub. No.: US 2002/0199182 A1
(43) Pub. Date: Dec. 26, 2002

(54) Method and apparatus providing convergent solution to end-to end, adaptive business application management

(76) Inventor: Susan Whitehead, Wassenaar (NL)

Correspondence Address: HARRINGTON & SMITH, LLP, 4 RESEARCH DRIVE, SHELTON, CT, 06484-6212, US

(21) Appl. No.: 10/029,366

(22) Filed: Dec. 19, 2001

Related U.S. Application Data
(60) Provisional application No. 60/269,007, filed on Feb. 15, 2001.

(51) Int. Cl. H04N 7/16; G06F 17/60; H04K 1/00; H04L 9/00

(52) U.S. Cl. 725/1; 705/52; 705/34

(57) ABSTRACT

An enterprise or business system is disclosed that provides content and services to customers over an infrastructure. The system includes a plurality of business application modules and associated databases, and further includes a bus, such as an enterprise application integration (EAI) bus, for interconnecting the plurality of business application modules, the associated databases and customer equipment. The EAI provides an inter-application module and customer equipment messaging function and message/data translation capability. In the preferred embodiment at least one of the plurality of business application modules is a customer billing application module that cooperates with others of the plurality of business application modules and the customer equipment through the EAI for generating, for individual ones of the customers, a bill that contains a unified accounting of all of the content and services received by the customer through the infrastructure.

### CROSS-REFERENCE TO RELATED APPLICATION

This application claims priority under 35 U.S.C. §119(e) on U.S. provisional patent application No. 60/269,007 filed Feb. 15, 2001.

### BACKGROUND OF THE INVENTION

1. Field of the Invention

This invention relates generally to computerized methods for conducting business and, more particularly, relates to systems and methods for integrating a number of business application functions and modules into a coherent whole, wherein information is transferred as needed between the applications over a bus, and more specifically relates to improved methods for conducting business with regard to provisioning customers with a cable/wireless infrastructure, for delivering services and content to customers over the cable/wireless infrastructure and for billing the customers appropriately. In a preferred, but not limiting, embodiment the bus is an Enterprise Application Integration (EAI) backbone bus.

2. Brief Description of Prior Developments

A number of problems can arise with regard to a business model wherein a business event leads to or triggers transactions that involve a number of business applications. These business applications can include customer care, customer provisioning, inventory control, billing, etc. This is especially the case when the business organization or enterprise is distributed over a wide geographic area that may cross national borders and time zones, as well as language, tax and currency boundaries.

It can be appreciated that the various business applications that make up the overall business model will typically have different data format requirements, input/output requirements, database structures with differing search/retrieval requirements, etc., thereby complicating the integration of such applications into a working and coherent whole.

Furthermore, the billing application itself can be made quite complex in a business model that provides a number of different types of services to customers or subscribers. In an example that is most germane to the teachings of this invention, a business that provides various types of content and different types of services to subscribers over a distribution system or network is required to bill the subscribers for the content and services that are used and/or ordered by each individual subscriber. A desirable goal would be to generate a single unified statement or bill for each subscriber that reflected the total amount of such content and the various and different content-related and other services that the subscriber may be provided during some interval of time.

### OBJECTS AND ADVANTAGES OF THE INVENTION

It is a first object and advantage of this invention to provide an improved method of conducting business that overcomes the foregoing and other problems.

It is a further object and advantage of this invention to provide an integrated cable/wireless provider business model wherein a plurality of business applications communicate over an Enterprise Application Integration (EAI) bus, and wherein a unified and coherent subscriber billing process is realized.

### SUMMARY OF THE INVENTION

The foregoing and other problems are overcome and the foregoing objects and advantages are realized by methods and apparatus in accordance with embodiments of this invention.

In one aspect, this invention provides a modular, scalable, end-to-end business method for providing content and services to customers over an infrastructure, and for accounting for the use of the content and services by individual ones of the customers. The method includes steps of providing a business system as a plurality of business application modules and associated databases that are coupled together through a bus, such as an enterprise application integration (EAI) bus. The EAI bus further provides an inter-application module and customer equipment messaging function and message and data translation capability. The method includes a further step of periodically transmitting billing-related messages through the EAI bus from customer equipment to a customer billing application module, the billing-related messages containing information concerning a customer's usage or ordering of at least one of telephony, cable television, interactive television, pay-per-view events, video-on-demand, near video-on-demand, digital television, Internet access and other similar products. A further step of the business method operates the customer billing application module cooperatively with others of the plurality of business application modules and with the customer equipment through the EAI bus for generating, for individual ones of the customers, a bill that contains a unified accounting of all of the content and services received by the customer through the infrastructure.

In a further aspect, this invention provides an enterprise or business system that provides content and services to customers over an infrastructure. The system includes a plurality of business application modules and associated databases, and further includes a bus, such as an enterprise application integration (EAI) bus for interconnecting the plurality of business application modules, the associated databases and customer equipment. The EAI bus provides an inter-application module and customer equipment messaging function and message/data translation capability. In the preferred embodiment, at least one of the plurality of business application modules is a customer billing application module that cooperates with others of the plurality of business application modules and the customer equipment through the EAI bus for generating, for individual ones of the customers, a bill that contains a unified accounting of all of the content and services received by the customer through the infrastructure.

In the preferred embodiment, the infrastructure contains at least one of coaxial cable, optical fiber and a wireless network, and the content and services include all or some of telephony, cable television, pay-per-view events, video-on-demand, near video-on-demand, digital television and Internet access.

In the preferred embodiment, the EAI bus employs a publication and subscription messaging protocol for providing messaging between the plurality of business application modules and the customer equipment. For example, the customer equipment may be provisioned by one of the plurality of business application modules through the EAI bus, and the customer equipment may operate to periodically transmit billing-related information through the EAI bus to the customer billing application module.

### BRIEF DESCRIPTION OF THE DRAWINGS

The foregoing aspects and other features of the present invention are explained in the following description, taken in connection with the accompanying drawings, wherein:

FIG. 1 is an overall simplified block diagram of a business system in accordance with the teachings of this invention, wherein a plurality of business applications or modules are interconnected through an enterprise application integration (EAI) bus;

FIG. 2 illustrates a plurality of databases associated with different ones of the business modules of FIG. 1, and further shows data mapping operations performed by the EAI bus;

FIG. 3 depicts an example where the EAI bus is implemented as a plurality of instances that operate in a federated manner;

FIG. 4 is an example of work flow involving various ones of the business modules and the EAI bus of FIGS. 1 and 2 for initiating a billing process when responding to a customer request to be provisioned with a service;

FIG. 5 is a simplified block diagram of a portion of the business system, and which is useful for presenting an example of the operation of the business system;

FIG. 6 is a chart of architecture guiding principles and desired business requirements for design of features incorporation the present invention;

FIG. 7A is a diagram of an administration system for three telecommunication systems;

FIG. 7B is a chart of a seven groups or families architecture for a telecommunications administration system;

FIG. 8 is a block diagram of an architecture overview of a system incorporation features of the present invention;

FIG. 9 is a block diagram overview of major components of the system shown in FIG. 8;

FIG. 10 is a technical architecture overview of some of the components for the system shown in FIG. 8;

FIG. 11 is a process architecture overview of the system shown in FIG. 8;

FIG. 12 is a block diagram of key data objects for some of the software used in the system shown in FIG. 8;

FIGS. 13A-13I are diagrams of key data objects for some of the software used in the system shown in FIG. 8;

FIG. 14 is a block diagram of one type of execution architecture used with the Arbor/BP™ software;

FIG. 15 is a block diagram of one type of execution architecture used with the Comptel™ software;

FIG. 16 is a block diagram of one type of execution architecture used with the ClickSchedule™ software;

FIG. 17 is a block diagram of one type of execution architecture used with the Product Organizer software;

FIG. 18 is a block diagram of one type of execution architecture used with the Doc1™ software;

FIG. 19 is a block diagram of one type of execution architecture used with the Capacity Requester software;

FIG. 20 is a block diagram of one type of execution architecture used with the ASAP™ software;

FIG. 21 is a block diagram of one type of execution architecture used with the Vitria™ BSS software;

FIG. 22 is a block diagram of one type of execution architecture used with the Vitria™ OSS software;

FIG. 23 is a block diagram of one type of system having multiple regional control centers;

FIG. 24 is a block diagram of an application architecture for one of the regional control centers shown in FIG. 23; and

FIG. 25 is a block diagram of application architecture for another one of the regional control centers shown in FIG. 23.

### DETAILED DESCRIPTION OF THE PREFERRED EMBODIMENTS

A type of business enterprise of most concern to the teachings of this invention is one based on a content, service and information distribution network that includes a coaxial cable and/or fiber optic and/or wireless infrastructure through which customers or subscribers are provided with one or more of, by example, telephony, television (TV) signals, interactive TV (ITV), digital TV (DTV), Internet access, possibly including voice-over-Internet or voice-over-IP services, pay-per-view (PPV) events such as films and sporting events, video-on-demand (VOD) services, near VOD and/or similar products. As employed herein VOD implies that a customer is provided with immediate or near immediate access to a requested video, and may also have the capability to stop, start, restart, rewind, etc., the selected video, while near VOD can be achieved by playing the same video on a plurality of channels in a time-staggered manner. For example, four channels show the same video, with the second channel starting 15 minutes after the first, the third channel starting 15 minutes after the second, etc. In this case the customer has a more limited capability to alter the viewing sequence than can be achieved with VOD.

The wireless infrastructure, if used, can include one or more of, by example, a wireless local loop (WLL) network or a network at least partially carried through one or more satellites.

While the teachings of this invention will be made in the context of this type of content, service and information distribution network business enterprise, it should be kept in mind that the teachings of this invention are not limited to only this particular type of business enterprise or business model, and that the teachings in accordance with this invention may be applied in whole or in part to other types of business enterprises and models including, but not solely limited to, the utility industry (e.g., electric power distribution, natural gas distribution), as well as to telephone service providers, Internet service providers and TV service providers such as satellite and cable TV providers.

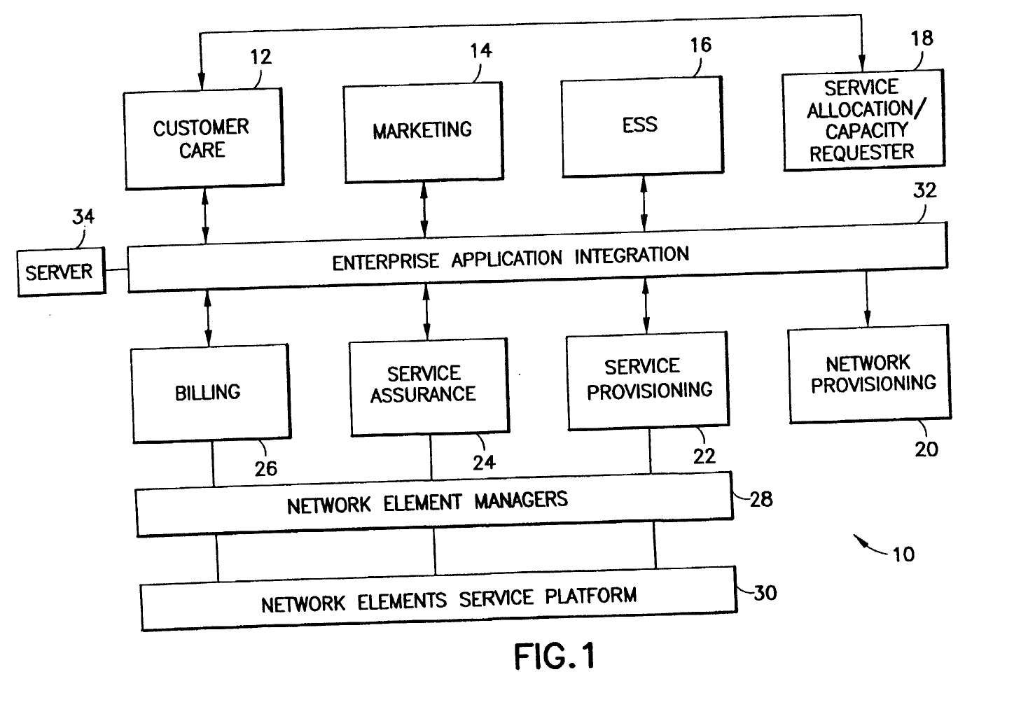

Reference is now made to FIG. 1 for showing an overall simplified block diagram of a business system 10 in accordance with the teachings of this invention. A plurality of business or enterprise applications, also referred to herein as modules, include by way of example and not as a limitation, a customer care module 12, a marketing/sales/supply chain module 14, an Enterprise Support System (ESS) module 16, a service allocation capacity requester module 18, a network provisioning module 20, a service provisioning module 22, a service assurance module 24 and a billing module 26. The service provisioning module 22, service assurance module 24 and the billing module 26 are interfaced with a network element managers layer 28, which in turn is interfaced with a network elements service platform 30. A bus, preferably an enterprise application integration (EAI) backbone, layer or bus 32, is provided for interconnecting most of the enterprise application modules 12 through 26, thereby facilitating the flow of information between them as will be described in further detail below.

Describing now these various modules and layers in further detail, the customer care module 12 includes a customer call center for receiving telephone calls from customers, a customer self-care center (that may use various media such as Internet (Web) self-care and digital television (DTV) self-care, which also enable access to a customer's billing information), a contract management and order entry center, a sales management center, an order processing center, a work distribution and logistics center, a trouble ticketing and customer inquiry center and on-line access to product catalogs, including product structure, pricing and discounting. Various databases are also associated with the customer care module 12, including a customer profile database, a service orders database, a service requests database and an inventory database. Through the use of the customer care module 12 the customers of the business system 10 are able to phone in requests for, or request on-line, new equipment installations, modifications or deletions, or the customers may schedule service appointments, report equipment trouble, as well as request help from the system provider. The system provider is enabled to provide order management and credit check functions, street address guides, credit requests and adjustments, collections, customer trouble report management, directory assistance and emergency services, among others. Real-time order entry, as well as system and network resource availability checking is made possible, as is verification of customer premise equipment (CPE) availability, work force time slot information, telephone number assignment and real-time status.

The marketing module 14 includes a product and services management center and a data warehousing center associated with a data warehousing database. A products database is also associated with the marketing module 14. Through the use of the marketing/sales module 14 the system provider is also enabled to provide product information and pricing, marketing and sales information and support, telemarketing, lead tracking and sales force automation, as well as other marketing and sales related functions. The marketing module 14 may also include a sales and order entry functionality, or this functionality may be provided by a separate module, and possibly database(s), that are also coupled to the EAI bus 32.

The ESS module 16 is most relevant to the service provider, as it contains various general accounting, human resources, document management, workforce management and other enterprise-related functions.

The service allocation/capacity requester module 18 operates in conjunction with a service inventory database and provides a capacity requester function for the customer care module 12. For example, the customer care module will send a request (e.g., can I provision this customer?), and the service allocation/capacity requestor module 18 will provide the required information.

The network provisioning module 20 assists in planning network enhancements and operates with a network inventory and a network planning and forecasting database. The network provisioning module 20 includes a network inventory function, an access network planning and design function and a data network planning and design function. Capacity management functionality is also provided, as certain service availabilities, such as Internet services, are sensitive to capacity, which is preferably managed through network inventory during the operation of the service provisioning module 22, discussed below. Other functions included within the network provisioning module 20 include country-specific telephone number plan administration, network-specific network routing management and a network element catalog.

The service provisioning module 22 operates with an enterprise-specific and standardized service design database, as well as with a service provisioning and tracking database, and includes a first service provisioning and activation function for telephony services, a second service provisioning and activation function for Internet services and a third service provisioning and activation function for digital TV (DTV) services. These three functions communicate with corresponding voice, Internet services and video managers, respectively, in the network element managers layer 28, whereby command mediation and other functions are performed. These managers in turn communicate with corresponding Customer Premise Equipment (CPE), such as set-top computers, as well as with various appropriate access networks in the network elements service platform level 30. Other functions contained within the service provisioning module 22 may include design services, a service installation manager, as well as direct service activation, direct service testing and confirmation of service arrangement functions.

In general, the service provisioning module 22 provides multi-service, data-driven provisioning through predefined business rules to enable new services to be quickly launched. Real-time activation and configuration can be accomplished in cooperation with the customer self-care function, or through a customer service representative, of the customer case module 12. The service provisioning module 22 also maintains a unique service record representation by customer, with all customer services and rights being maintained, preferably but not necessarily, in a single logical database.

The service assurance module 24 assists in providing network assurances for maintaining network quality, trouble ticketing and integrated reporting, and operates in conjunction with a performance reports database and a technical trouble tickets database. The service assurance module 24 may implement a service simulation function, a SLA manager and associated performance reports database, and a trouble ticket function and associated technical trouble tickets database. A “manager-of-managers” function may be used, and if so, can be interfaced with a plurality of network and platform managers in the network element managers layer 28. These managers include vendor-specific access network managers, vendor-specific voice switch managers, cable and fiber head end (H/E) managers, a data network manager and an Internet servers manager. These various managers communicate alarms and events with the head end and switching systems, as well as with core networks, such as IP backbones, SDH, DWDM, etc. In general, the service assurance module 24 provides service supervision through the use of simulation tools, correlation between service alarms, network alarms and alerts, and proactive customer troubleshooting.

The billing module 26 operates in conjunction with a customer accounts database and includes a number of billing-related functions. These functions can include an interconnect rating and settlements function, a convergent rating, billing and accounting function, an accounts receivable and reports function, a data/DTV usage collection function, a voice services usage collection function and a fraud management function. Also included are various bill calculation and formatting functions, carrier bill audit and control functions, payment processing and revenue assurance functions and clearance functions. The billing module 26 is interfaced to voice, Internet and video carriers of the network elements management layer 28 via various usage and call collectors. These elements of the network element managers layer 26 are in turn interfaced with service platforms (e.g., Internet, TV, etc.) and external service access providers (e.g., Internet service providers (ISPs)) located in the network elements service platform layer 30.

The billing module 26 provides, in accordance with an aspect of this invention, an ability to account for and bill out various types of events (e.g., CDRs, pay-per-view, video-on-demand, eCommerce transactions, traffic volume, etc.) on a single unified customer bill, as well as an ability to configure and parameterize product and pricing structures for new offerings. The billing module 26 further provides an ability to handle complex and heterogeneous pricing schemes, an ability to perform “hot billing” for Internet services, and an ability to provide integrated account receivables for performing adjustment processing. The billing module 26 further provides, in the presently preferred embodiment, multi-language, multi-currency, multi-tax and multi-payment method capability, as well as cross-product discount capability.

As can be appreciated from the foregoing description, the bus 32, more particularly the Enterprise Application Integration (EAI) bus 32, is an important element of the business system 10, as information flows between the various modules 12 through 26 and associated databases over the EAI bus 32.

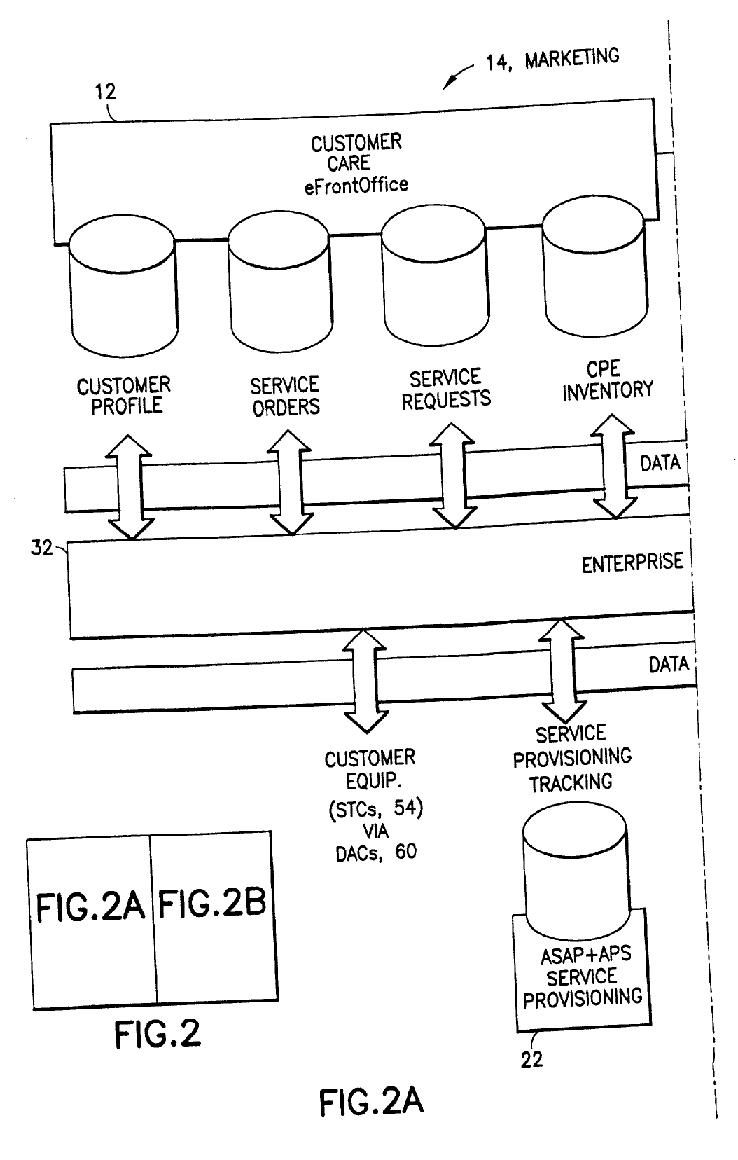

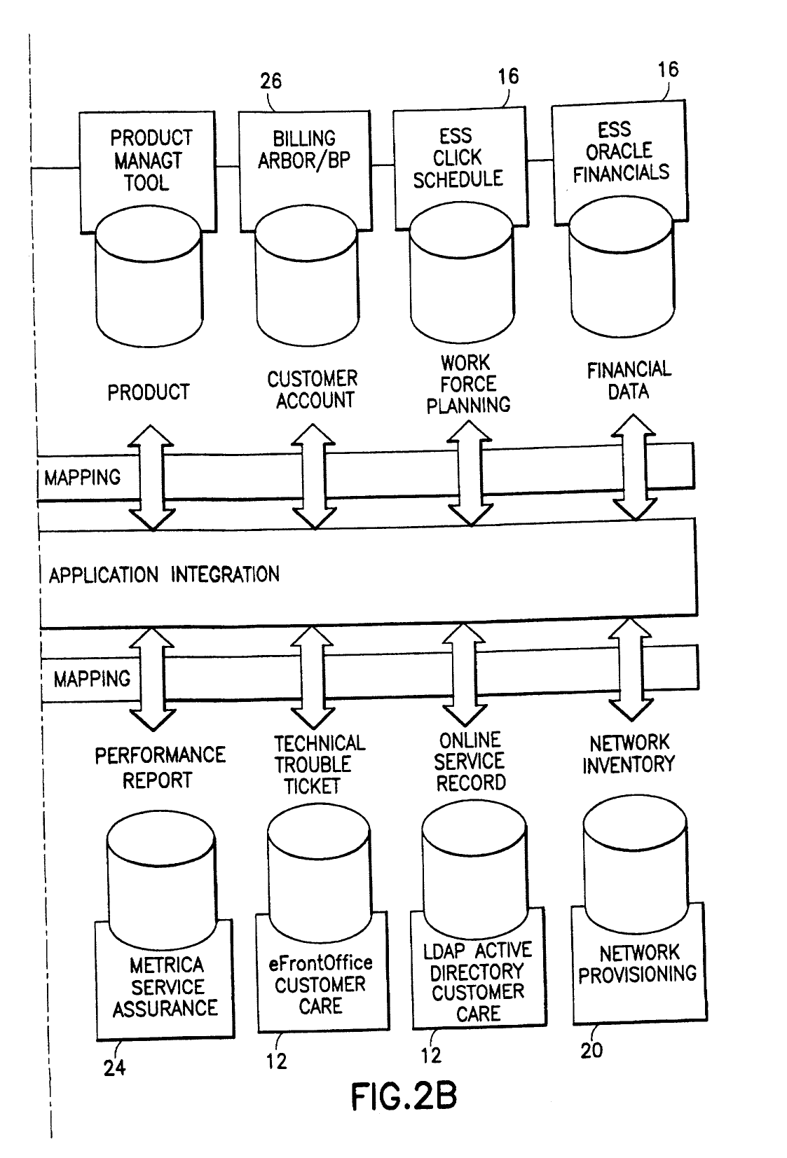

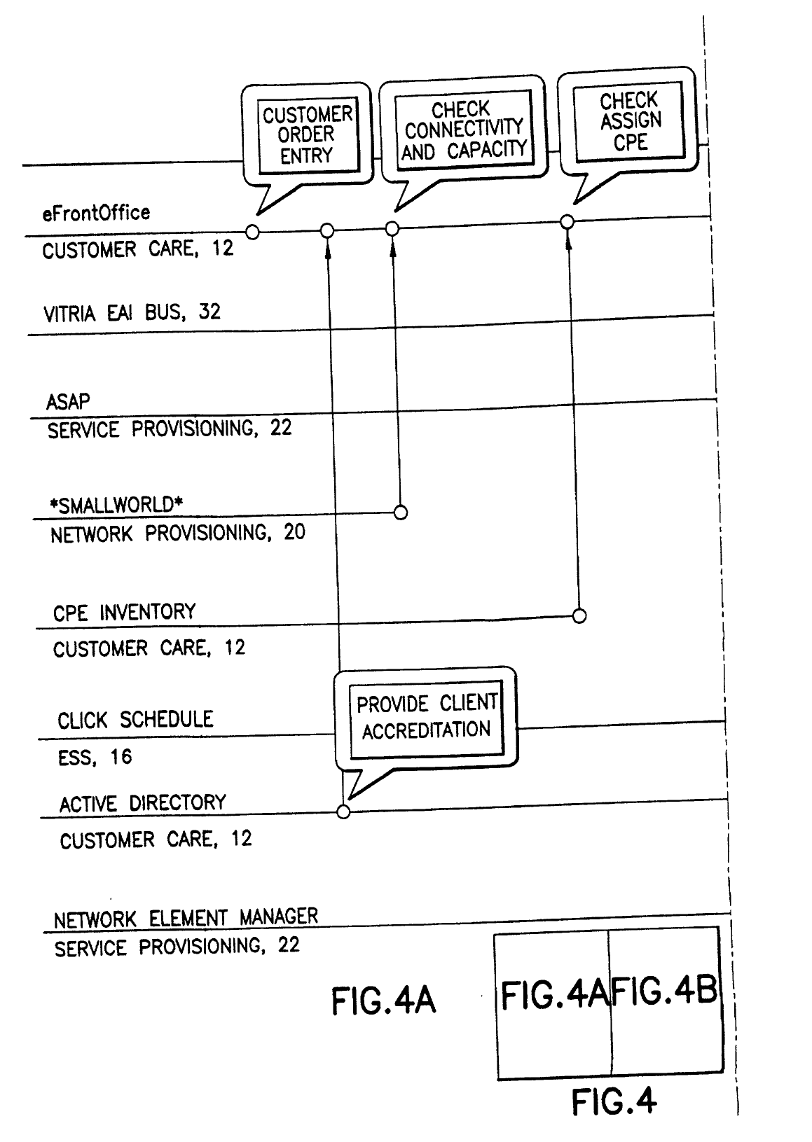

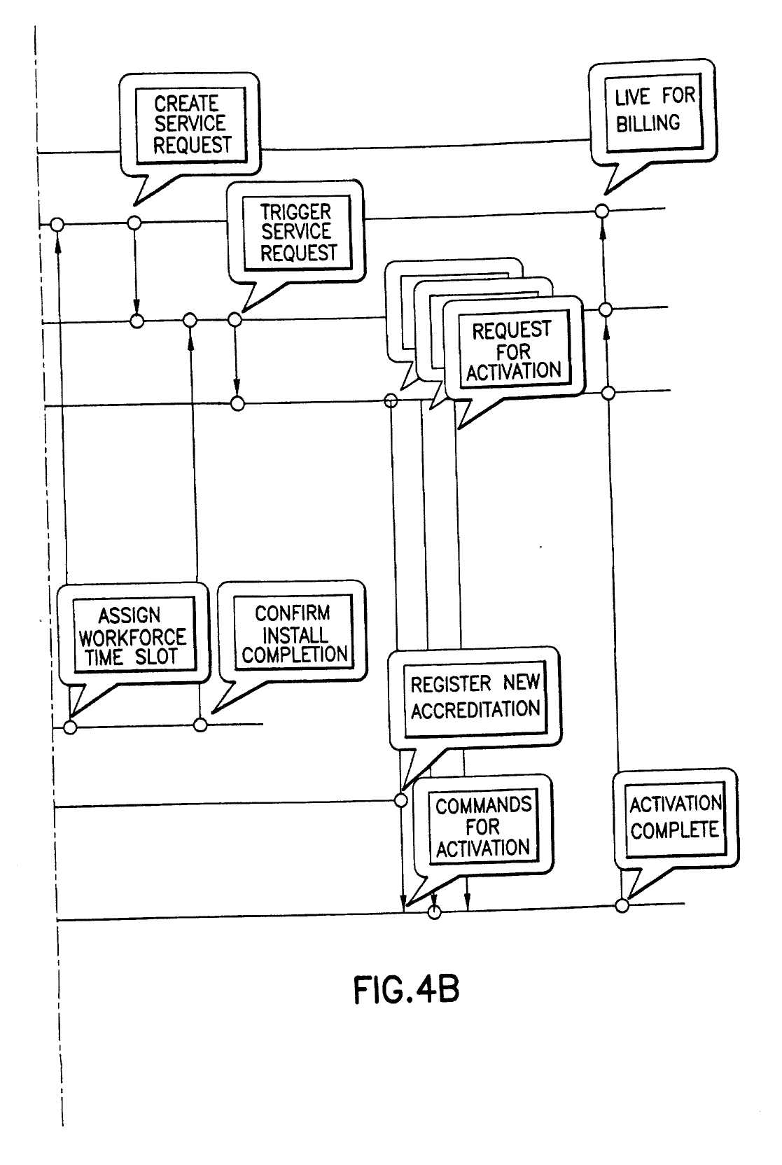

As is also shown in FIG. 2, in a presently preferred, but not limiting, embodiment of these teachings the EAI bus 32 provides data mapping services for information flowing between the various modules and their respective databases, as well as event-driven, real-time inter-application or inter-module communications, and also inter-data model data mapping for data flowing between various ones of the databases discussed above. The EAI bus 32 thus provides a mechanism to organize work flow, cooperation and synchronization between the various applications and functional modules 12 through 26. The EAI bus 32 is organized to permit messaging and message queuing, a message publishing and subscription service, inter-application guaranteed delivery, as well as data integration and transformation. An EAI server 34 functions as a message repository, and provides transaction support and security functions. Various connectors, discussed in further detail below, and Application Program Interfaces (APIs) are configurable for various network technologies, as well as for standard databases and pre-packaged applications, and furthermore provides support for interfacing to custom, proprietary and/or non-standard applications. Work flow and business process coordination are also provided (see, for example, FIG. 4). The data model is preferably an XML-based Meta Data model, although other data models can be used. In a presently preferred, but not limiting, embodiment the EAI bus 32 is implemented with a commercially available product known as Vitria BusinessWare™, which also implements and supports the desired work flow management functionality.

FIG. 2 illustrates a plurality of the above-mentioned databases associated with different ones of the business modules 12, 14, 16, 20, 22, 24 and 26 of FIG. 1, and further shows the data mapping operations performed by the EAI bus 32. In FIG. 2 the various business modules are shown with a constituent software module that performs a desired business system related function. The illustrated, largely commercially available software modules are exemplary, and are not to be construed in a limiting sense upon the practice of this invention. In the presently preferred embodiment, and by example, the customer care module 12 employs a module known as eFrontOffice™ for maintaining customer profiles, service orders, service requests, customer premise equipment (CPE) inventory and a record of technical trouble tickets, as well as a Lightweight Directory Access Protocol (LDAP) directory that provides an active online service record database. The LDAP directory stores information on every device and every customer, such as customer identifications (Ids), device Ids, Media Access Control (MAC) addresses, associations between specific customers and specific devices, Internet Protocol (IP) addresses (which can be assigned to a device), and the scope of the IP addresses, that is, what the IP address permits the device to do. The functionality of the LDAP directory is within the scope of IP provisioning provided by a technology known as the All Purpose ServiceWare (APS)™.

In the presently preferred embodiment the billing module 26 employs an Arbor/BP™ software package for maintaining customer account information, the ESS 16 employs a Click Schedule™ software package for work force planning and an Oracle Financials™ package for maintaining financial data. The network provisioning module 20 may use a unified network inventory system for maintaining network inventory, while the service assurance module 24 may use a package known as Netcool™ or a custom-designed package for maintaining service reports. The service provisioning module 22 uses a package known as an Automated Service Activation Program (ASAP™) for configuring voice (telephony) switches and a package known as Jacobs Rimmel APS™ for Internet service provisioning of customers. As is evident, the EAI bus 32 interconnects these various modules and databases, enabling data sharing, messaging and format conversion as required.

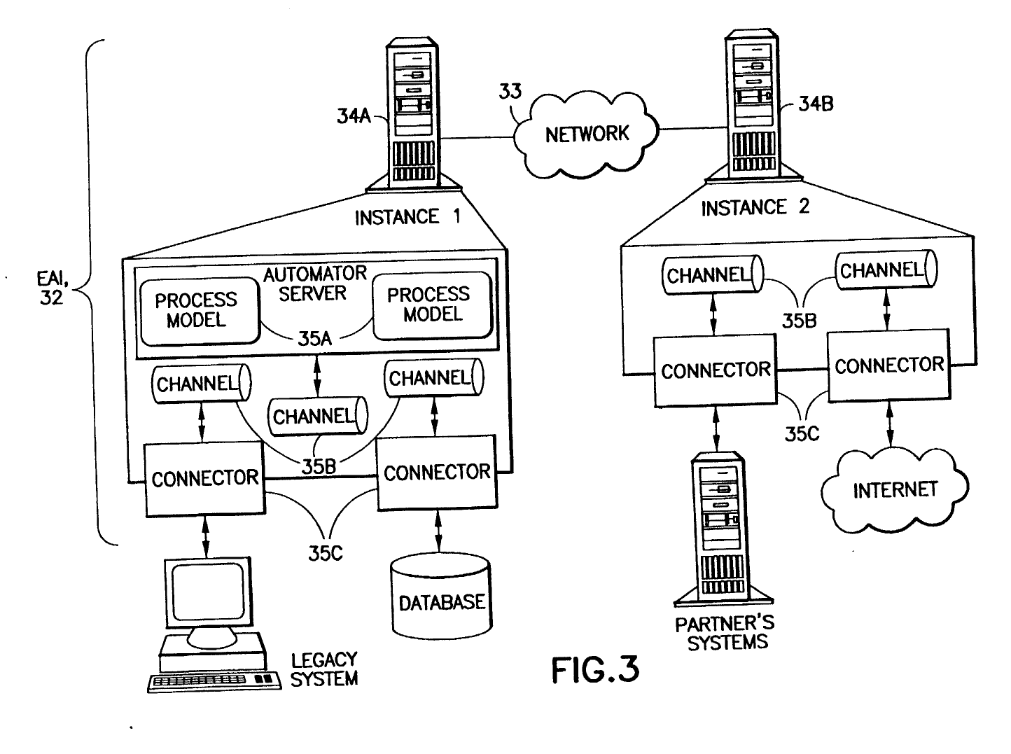

FIG. 3 depicts an example where the EAI bus 32 is implemented as a plurality of instances (1 and 2) that operate together. In this example the EAI bus 32 is implemented as a first instance that is embodied in EAI server 34A and as a second instance embodied in EAI server 34B. The second EAI server 34B instance may be geographically distant from the first instance, and connectivity is achieved through a data communications network 33. In this distributed type of EAI system each EAI component functions in a manner analogous to a Common Object Request Broker Architecture (CORBA) server which can be remotely distributed across several machines, and in which communication is achieved by using an Internet Inter Orb Protocol (IIOP) over the network 33.

In the example illustrated in FIG. 3 the EAI instance 1 may provide connectivity to the (legacy) customer care and billing modules 12 and 26 through appropriate connectors 35C. It also provides automation of processes and interactivity with the local database(s), as described above. The EAI server 34A can thus be seen to include applicable process models, and communicates over channels 35B using a “publish and subscribe” communication model.

The channels 35B are coupled to the connectors 35C. In the presently preferred, but not limiting, embodiment of this invention the connectors 35C operate so as to map application or business module-specific communication protocols and data formats into protocols and formats that are based on Internet standards, and thus simplify and unify the exchange of information between different applications, business modules and databases. The connectors 35C can be pre-built connectors designed to interface with a variety of different third party application software (e.g., Clarify™, Arbor BP™, Oracle™, etc.), or they may be custom connectors designed for interfacing with applications for which pre-built connectors do not exist.

In the example of FIG. 3 the second instance of the EAI bus 32 may provide a connection to various business partners and to customers via the Internet. As an example, a business partner may be a bank that enables customers to access their account information using the interactive capability provided by the business system 10, or a business partner may be an airline that provides bonus miles to the customers of the business system 10 in return for their purchase of services. Of course, many other types of potential business partners and business partner relationships may be envisioned by those skilled in the art, when guided by the teachings of this invention.

FIG. 4 is an example of the automatic generation and management of work flow involving various ones of the business modules 12, 16, 22 and the EAI bus 32 when responding to a customer request to be provisioned with a new service (in this example: telephony). FIG. 4 makes evident the event-driven nature of the work flow that is a feature of the business system 10. Beginning with a customer order entry that is received and processed by the customer care module 12, a client or customer accreditation process initiates a first of a series of event triggers resulting in a check of connectivity and system capacity by the network provisioning module 20, a check of availability and a resulting assignment of the relevant customer premise equipment (CPE) by the customer care module 12, the assignment of a workforce timeslot to fulfill the customer's order by the ESS 16, followed by the creation of a service request, a verification of completion of the installation of the CPE, a service request trigger and associated request for activation, registering the customer's new accreditation, commands for activation of the new customer service, the initiation of billing for the new service, and finally the generation of a completion of activation event trigger.

The event-driven nature of the business system 10 extends beyond the provisioning of customers with services, as depicted in the example of FIG. 4. In the preferred embodiment of this invention other events that drive the system can include the initiation and termination of telephone calls, call timers, Internet log-on and log-off events, Internet usage (by time, by packet, and/or by some other usage metric), ordering a pay-per-view or a video-on-demand, suspension of and subsequently restarting an already ongoing video-on-demand, etc. All of these various events result in system triggers and messages that cause some appropriate action to be taken by one or more of the modules 12 through 26 of the business system 10, with one desired result being the generation by the billing module 26 of a consolidated customer bill that records and tracks the usage of a variety of different services and resources offered by the business system 10.

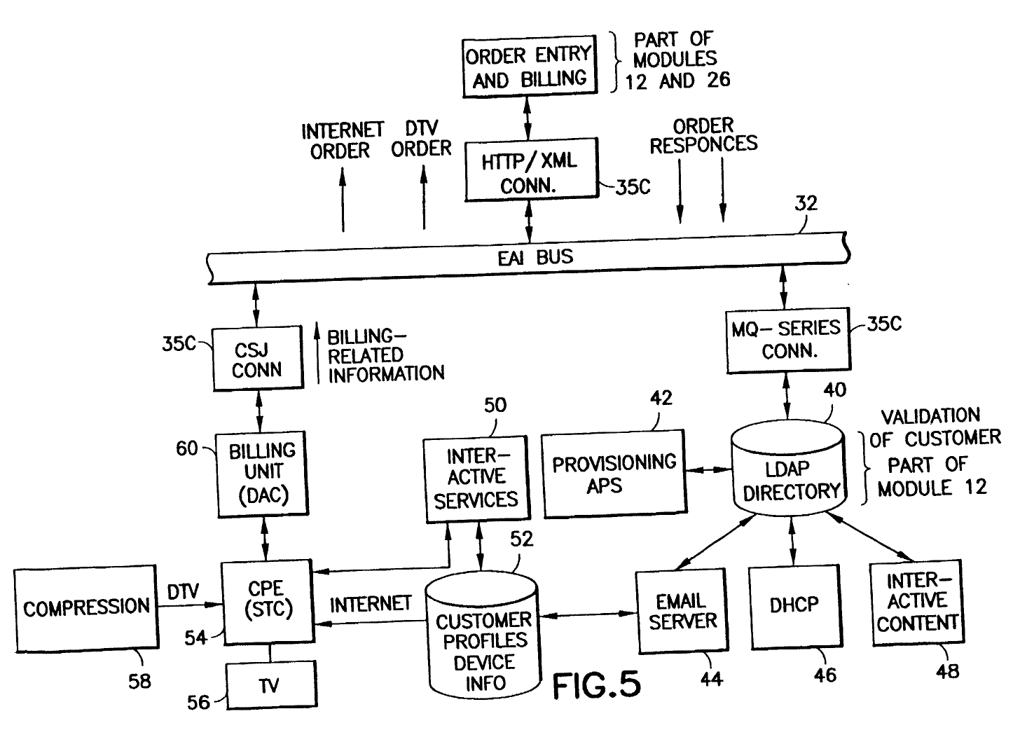

FIG. 5 presents a further example of the utility and operation of the EAI bus 32. In this example it is assumed that orders are received at the order entry module function (part of customer care module 12) for Internet and DTV. These two orders actually cause the generation of six message pairs: the DTV order message, a status update message, a DTV order response, the Internet order message, a status update message, and an Internet order response. These messages pass to and from the EAI bus 32 through, in this case, a Hypertext Transfer Protocol (HTTP)/XML connector 35C. The order messages are processed in cooperation with the LDAP directory 40, also part of the customer care module 12, and pass through an associated MQSeries™ (middleware) connector 35C. The LDAP directory 40 assists in the validation of the customer(s), and is connected with the provisioning All Purpose Service (APS) module 42, an e-mail server 44, a Dynamic Host Configuration Protocol (DHCP) module 46 and an interactive content module 48. An interactive services server 50 and a further customer profiles and device information database 52 communicate with the customer's CPE 54, connected with the customer's television 56. In the presently preferred embodiment the CPE 54 is actually a small set-top computer (STC) which has modems for DTV, Internet, etc. The DTV input can be provided from a content (decompression) unit or server 58, such as one known as a Thomcast SIMS™ server. A digital addressable controller (DAC) 60 is preferably embodied as a DAC6000™, available from Motorola, that contains a provisioning digital port and an Impulse Pay Per View (IPPV) digital port, and operates to record the activity of the customer's devices, and thus provides billing-related information through a custom synchronous Java (CSJ) connector 35C to the EAI bus 32. This billing information, related to both Internet usage and DTV usage, is collected by the billing module 26, and is used during the compilation of the unified customer bill in accordance with an aspect of this invention.

An example of the pre-provisioning of the DAC 60 is as follows. Prior to a customer's order(s) received at the customer care 12 order entry function various appropriate set top computer (STC) identifiers are scanned into the order entry system (which may be implemented using a software package known as Clarify™). For each STC identifier the order entry function creates a new pre-provisioning order. The EAI bus 32 passes an appropriate pre-provisioning order message that is intended to add the STC identifiers or serial numbers to the DAC 60 database. The message is passed into the DAC CSJ connector 35C from the EAI bus 32. The DAC CSJ connector 35C translates the received pre-provisioning order into a DAC specific command and routes the command to an appropriate serial port of the DAC 60. Once the new serial number(s) have been successfully added to the DAC's database, the DAC 60 returns a response message. The response message is passed through the CSJ connector 35, to the EAI bus 32, through the HTTP/XML connector 35C, and into the order entry function of the customer care module 12.

This type of message generation, message passing and message response protocol is also followed for subsequent actions, including the actual installation process for the requested service, which may require the scheduling and presence of a field technician, the actual provisioning of a service requested by the customer, and a disconnection process.

During a mediation process the DAC 60, such as the DAC6000, polls the STC 54 periodically (e.g., once per day) to collect its purchase data (e.g., a number of PPV movies that were ordered, the total time (or some other metric) that the customer spent connected to the Internet, etc.) The purchase data is stored in the DAC's database, and a message is subsequently received from the EAI bus 32 to upload the purchase data. This message is sent to the DAC 60. Upon receipt of the order, the DAC 60 stores the purchase data in a backup database, and then sends a message containing the purchase data through the CSJ connector 35C to the EAI bus 32. The purchase data is then passed to the billing module 26, which sends an acknowledgment message each time it receives a purchase data record. The purchase record acknowledgment messages are sent to the DAC 60 via the EAI bus 32 and the CSJ connector 35, and the DAC 60 eventually clears the purchase records stored in the STC 54 and also resets a purchase limit that is programmed into the STC 54.

It should be appreciated at this point that the foregoing presently preferred architecture of the business system 10 enables the replication of the architecture across entities and product lines, thereby improving the quality of service, ease of operation, and an ability to rapidly roll-out new products and services. The business process automation that is inherent in the architecture enables business events to lead to transactions that imply many applications (e.g., customer care, provisioning, inventory, billing, etc.) that require real-time communication, transaction guaranteed message delivery and business process automation through work flow management techniques. The business process automation also enables business rules (e.g., service activation) to be defined in a single location and shared between applications through work flow techniques. The architecture is such that the various modules and applications can be supervised both locally and centrally.

The business system architecture also preferably employs a limited number of well-defined APIs, providing scalability and openness, thereby enabling new applications to be readily interfaced and integrated into the architecture.

Due to the large number of customers, and therefore the large number of resulting triggered business events, and also due to the complexity of typical transactions, a high transaction throughput is provided to enable, if possible, transactions to occur during customer contact.

The common (shared) data entities that flow through the EAI bus 32 are managed so as to prevent inconsistencies across the multiple module databases, and preferably an “owner” module or function is defined for each shared data entity to help insure consistency.

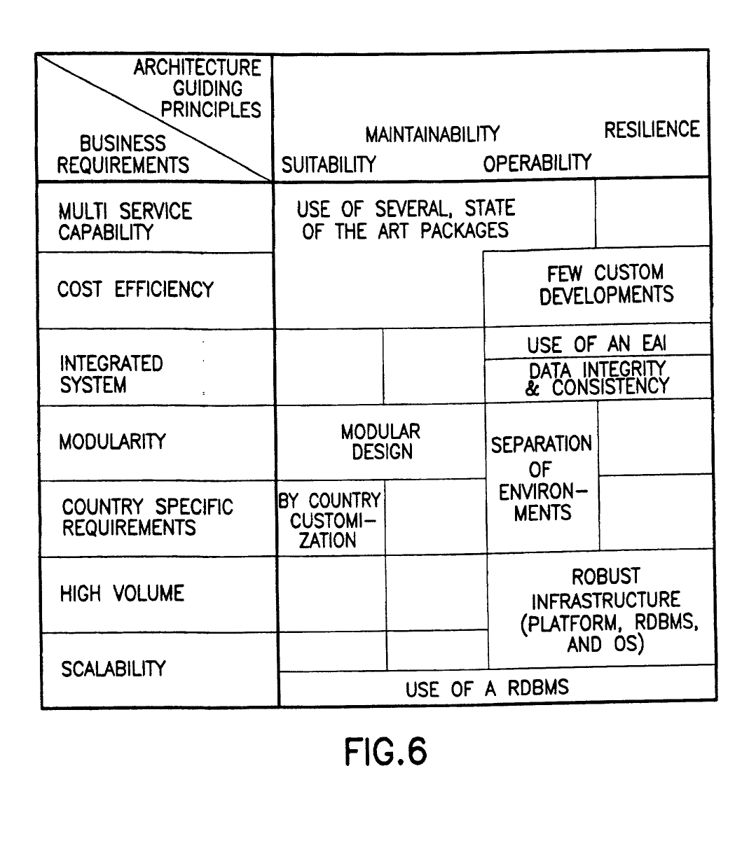

Referring now to FIG. 6, a chart is shown illustrating architectural guiding principles and desired business requirements which features of the present invention are intended to address. The primary desired business requirements being addressed include multi-service (telephone, television, Internet) capability, cost efficiency, system integration, system modularity, system adaptability to country specific requirements, system adaptability to high-volume, and system scalability. The primary architecture guiding principles include suitability, maintainability, operability and resilience. The present invention can use several state of the art software packages to provide suitability, maintainability and operability, in order to meet the desired business requirements of multi-service capability and cost efficiency. The present invention can also use only a few, limited custom software developments to enhance operability and resilience while maintaining the desired business requirement of cost efficiency. The present invention can make use of an enterprise application integration (EAI) package and can maintain data integrity and consistency among software packages to provide operability and resilience while meeting the desired business requirement for an integrated system. The present invention can make use of modular designs to provide suitability and maintainability while meeting the desired business requirement for modularity, and use separation of environments for operability while meeting the desired business requirements for modularity and country specific requirements. The present invention can make use of country customization to provide suitability while meeting the desired business requirement for country specific requirements. The present invention can use robust infrastructure to provide operability and resilience while meeting the desired business requirements for high volume and scalability and also make use of a relational database management system (RDBMS) such as provided by Oracle for suitability, maintainability, operability and resilience for meeting the desired business requirement for scalability.

There are various different rationales for providing this type of design system. The design system allows the use of the best of class in each domain. The design system reduces risks and allows use of reusable, independent components. The design system allows for use of country specific components and releases. Inter-component data flows can be centrally managed. Use of consistent data models provide compatible components to now be used together in a single system. The design system can allow for use of specific, independent servers and independent domain management. The design system can use robust and sound industry standards such as Unix and Oracle. The design system can provide scalable, maintainable, and easier to operate applications.

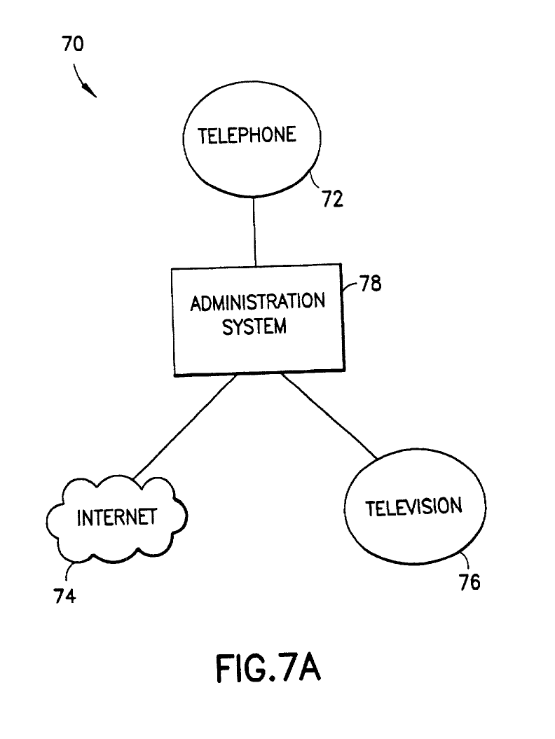

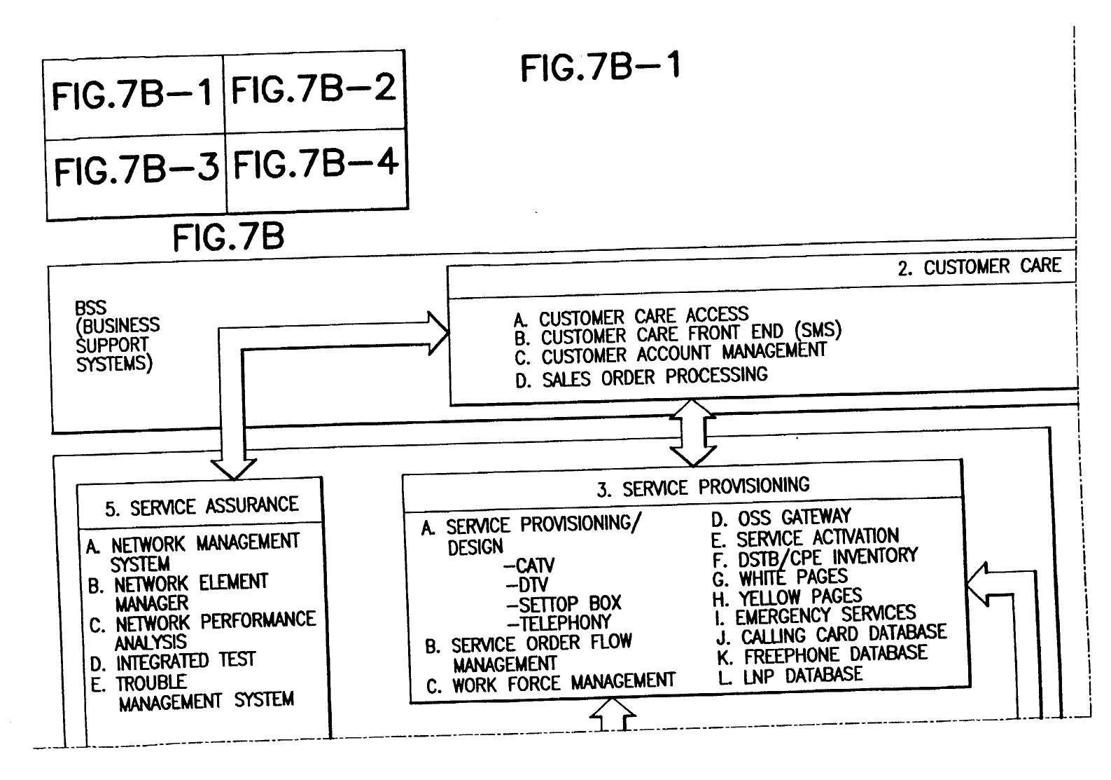

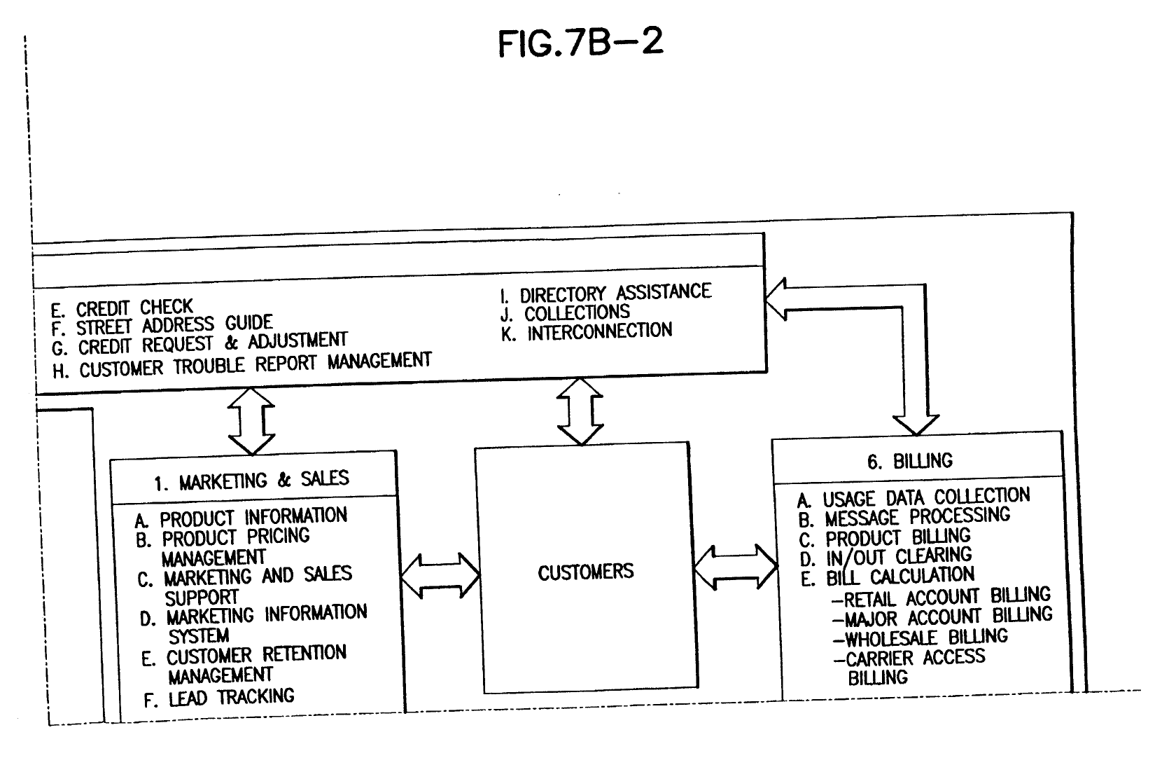

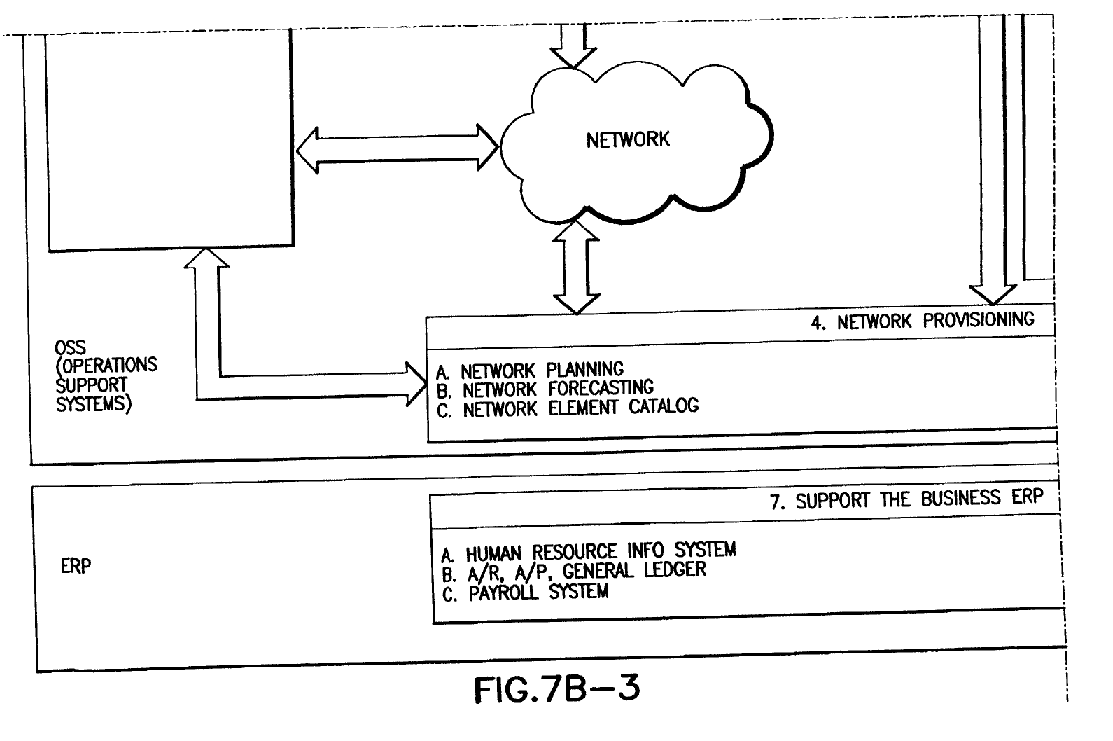

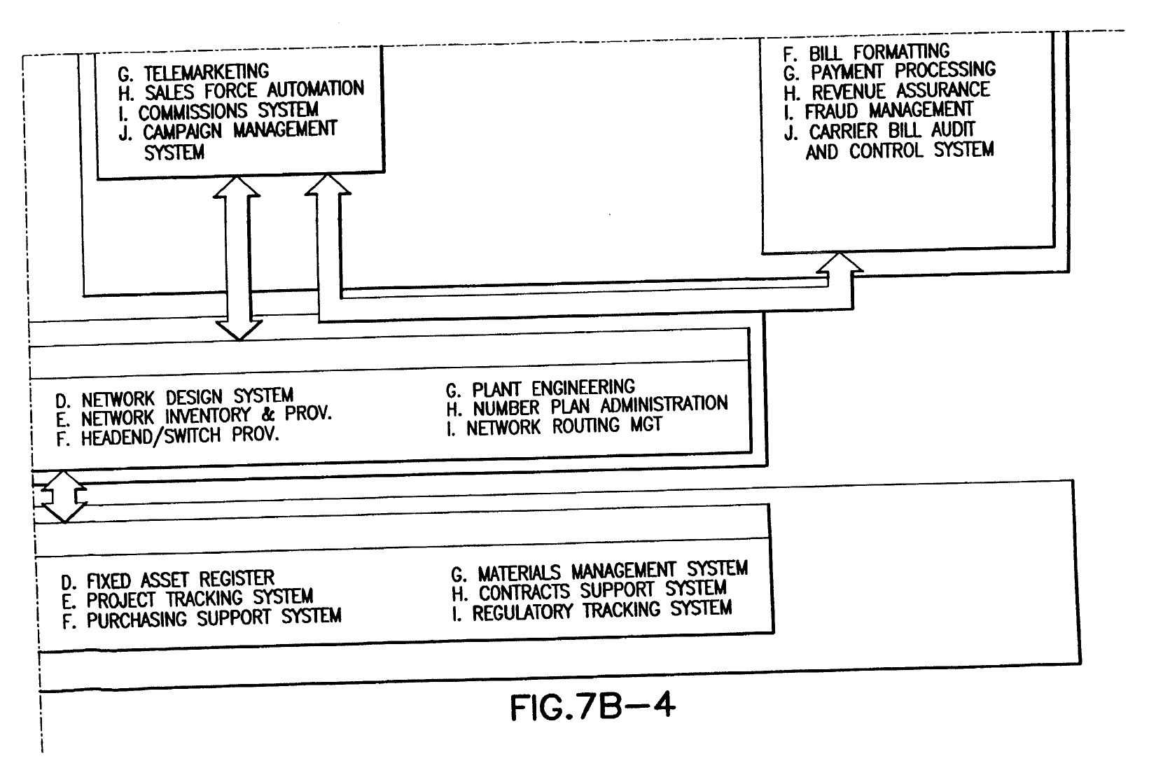

Referring now to FIG. 7A, a simplified diagram of a multi-service telecommunications system 70 incorporating features of the present invention is shown. The system 70 generally comprises a telephone service delivery system 72, an Internet service delivery system 74, a television service delivery system 76, and a multi-service administration system 78. In alternate embodiments, the system might comprise only two or more than three of the telecommunications service delivery systems. The telecommunications service delivery systems 72, 74 and 76 are generally well known in the art. The system 70 could comprise any suitable type of telecommunications service delivery systems.

One of the features of the present invention is implementation of features of the present invention in pre-existing telecommunications and administration systems. Referring also to FIG. 7B, an overview of management of the relationship between a customer and a supplier that might be used in a telecommunications and administration systems is shown. The overview includes a beginning of the customer/supplier relationship (order/activation) through the customer lifecycle (billing, problems) until its end (termination of service).

The diagram in FIG. 7B provides the overview of business capabilities on which the original capability assessment for virtually any telecommunications system can be based. The capabilities are grouped into seven groups or families of capabilities. These families are further grouped into business support system (BSS) capabilities, operational support system (OSS) capabilities, and ERP capabilities. The BSS capabilities include marketing and sales, customer care, and billing. The OSS capabilities include service provisioning, service assurance, and network provisioning. The ERP capabilities can provide general administrative support services to the supplier. As a result of a capability assessment of a pre-existing telecommunications system, given priorities in requirements for building new capabilities, calendar restraints, and budget constraints, a phased implementation approach can be used with a minimum of major implementation releases.

The generic business support system (BSS) business capabilities intended to be addressed with the present invention include marketing and sales, customer care, and billing. Marketing and sales includes multi-channel and multi-product sales (door-to-door, mail, telesales, “Web” sales, DTV sales, retailers, etc.), Sales representative incentive and local dealer commissioning, campaign management, customer segmentation, and lead tracking and customer contact history. Customer care includes the DTV based (IEG) and Web-based customer self care and access to billing information; call center scripting tools for handling customer requests; real-time order entry availability checking (e.g. customer area “ready for Service”, capacity of access network through a network inventory, CPE availability through CPE inventory, work force time slots, telephone number assignment, real-time status); on-line credit checking; trouble ticketing; on-line access to product catalogs (product structure, pricing and discounting) and bills for bill inquiry. Billing includes the ability to build various types of events (CDRs, pay-per-view (PPV), video-on-demand, ecommerce transactions, traffic volume, etc.) on a single bill; ability to configure and parameterize product and pricing structure for short-time to market; complex and heterogeneous pricing schemes; hot billing (Internet services); integrated account receivables (specially for adjustment processing frequent in cable industry); multi-language, multi-currency, multi-tax and multi-payment method capability; and cross product discount.

The generic operational support system (OSS) business capabilities intended to be addressed by the present invention include service provisioning, network services capacity management, and service assurance. Service provisioning includes multi-service provisioning; data driven provisioning through business rules to allow quick new services launching; service provisioning rules independent of commercial packaging; real-time activation and configuration by customer self care or by a customer service representative (CSR) during customer contact; unique service record representation by customer (all customer services and rights maintained in a single logical database); and workforce management. The network services capacity management includes management of addresses and homes passed; network topology management; management of telephone numbers; and management of technical resources for telephone, TV and Internet. service assurance includes services supervision performed through simulation tools; correlation between service alarms, network alarms and alerts; proactive customer troubleshooting; network provisioning and inventory; uniqueness of data model to allow maintenance deficiencies; and capacity management: Internet services availabilities sensitive to capacity, which must be managed through network inventory during service provisioning (Capacity Requester feature).

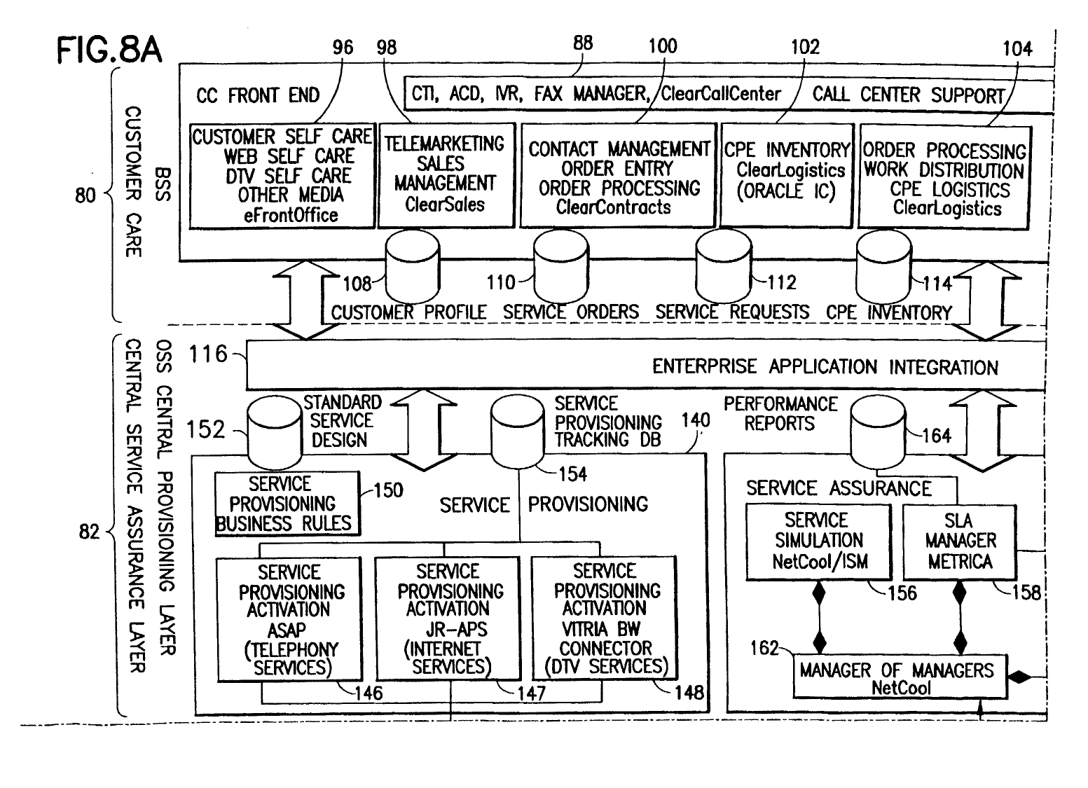

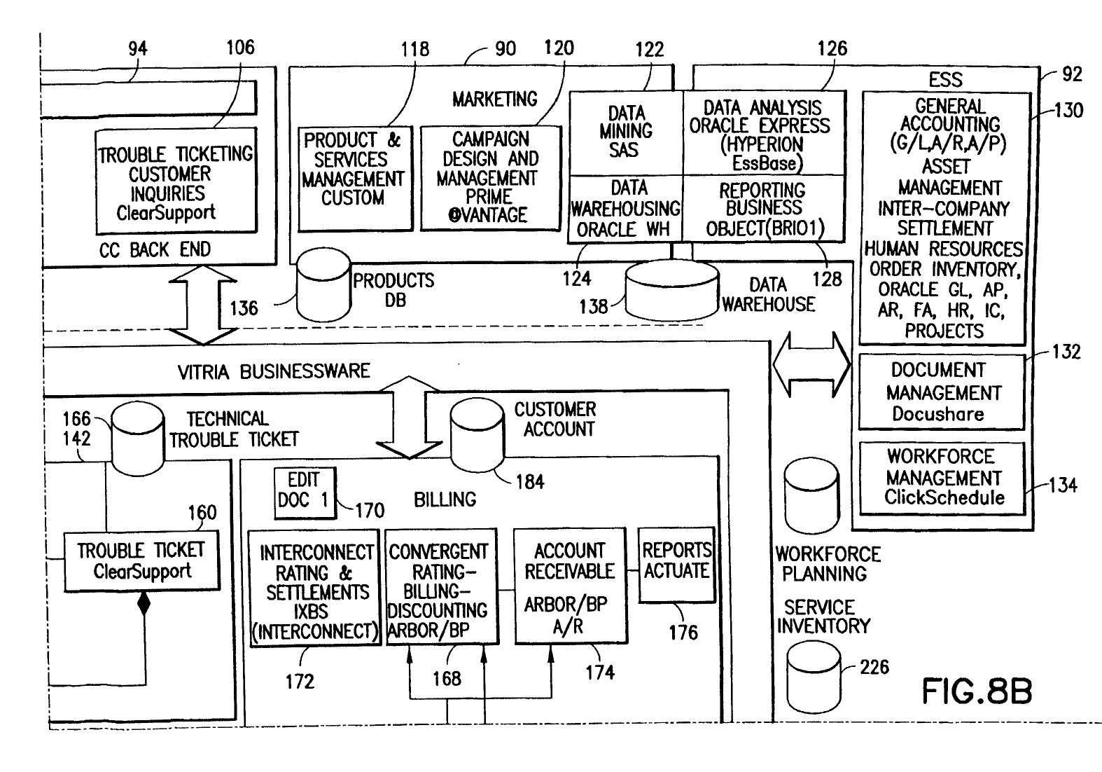

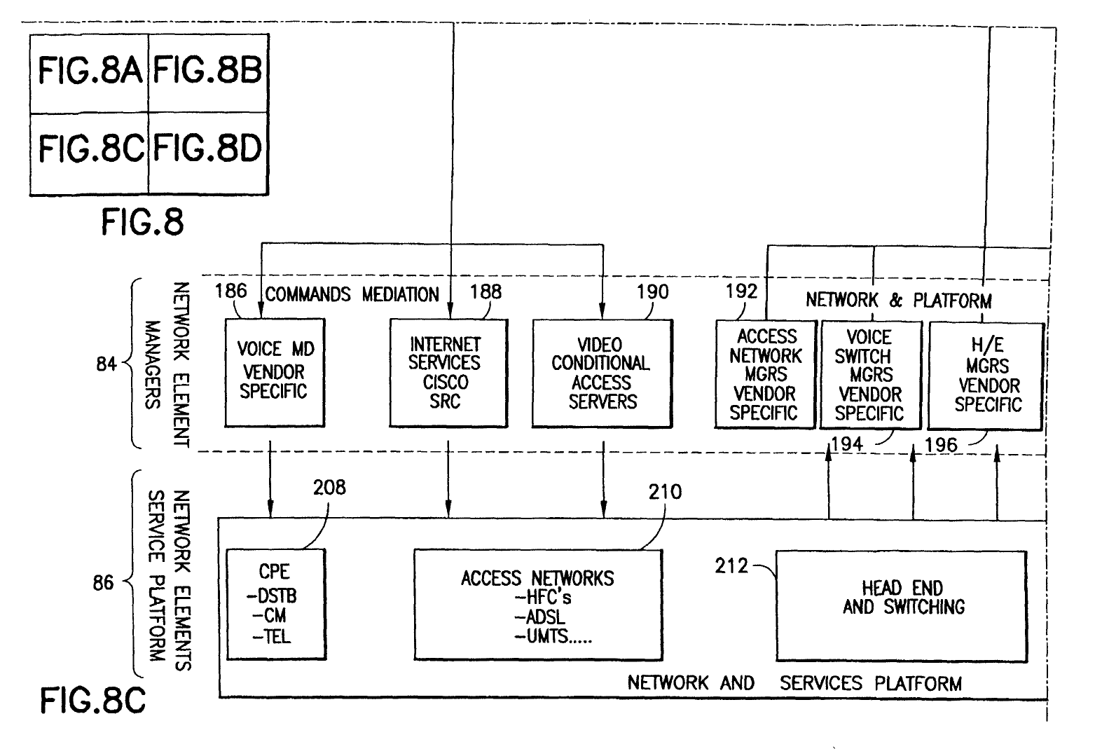

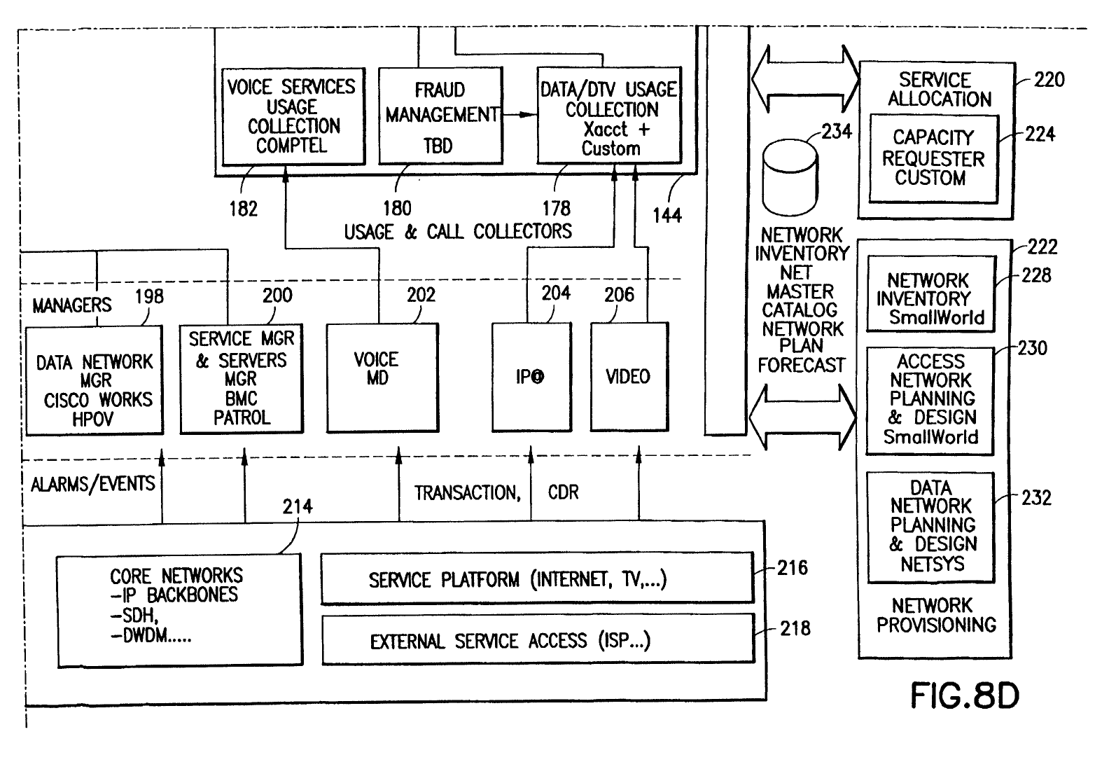

Referring now also to FIG. 8, a diagram is shown which provides an overview of the end-to-end application of features of the present invention in a telecommunications system. The diagram is divided into four areas comprising a BSS customer care area 80, and OSS central provisioning layer and central service assurance layer area 82, a network element managers area 84, and a network elements service platform area 86.

The BSS customer care area 80 generally comprises a customer care module 88, a marketing module 90, and an Enterprise Support System (ESS) module 92. The customer care module 88 generally comprises a call center support section 94, a customer self care section 96, a telemarketing/sales management section 98, a contact management/order entry/order processing section 100, a CPE inventory section 102, an order processing/work distribution/CPE logistics section 104, and a trouble tracking customer inquiry section 106. The customer care module 88 is functionally connected to various databases including, a customer profile database 108, a service orders database 110, a service requests database 112, and a CPE invoice database 114. In alternate embodiments, the customer care module 88 could comprise additional or alternative components. The customer care module 88 is operably connected to the enterprise application integration package 116 in the OSS area 82.

The marketing module 90 generally comprises a product and service management section 118, a campaign design and management section 120, and shares sections with the ESS module 92. The shared sections include a data mining section 122, a data warehousing section 124, a data analysis section 126 and a reporting section 128. The ESS section 92 further comprises a general accounting/asset management/inter-company settlement/human-resources/order inventory section 130, a document management section 132 and a workforce management section 134. In alternate embodiments, the ESS section 92 could comprise additional or alternative components. The BSS area 80 also includes a products database 136 and a data warehouse database 138. The ESS module 92 is also operably coupled to the enterprise application integration package 116.

The OSS area 82 generally comprises a service provisioning module 140, a service assurance module 142 and a billing module 144. In alternate embodiments, the OSS area 82 could comprise additional or alternative modules. The three modules 140, 142 and 144 are operably coupled to the EAI 116. The service provisioning module 140 generally comprises a plurality of different service provisioning and activation sections 146, 147, 148 (one for telephone service, one for Internet service and one for television service) and a service provisioning business rules programming 150. The OSS area 82 further comprises a standard service design database 152 and a service provisioning tracking database 154. The service assurance module 142 generally comprises a service simulation section 156, a SLA manager section 158, a trouble ticket section 160, a manager of managers section 162, a performance reports database 164, and a technical trouble tickets database 166. In alternate embodiment, the service assurance module 142 could comprise alternative or additional components.

The billing module 144 generally comprises a convergent rating-billing-discounting section 168, an edit section 170, an interconnect rating and settlements section 172, an accounts receivable section 174, the reports section 176, a data/DTV usage collection section 178, a fraud management section 180, a voice usage collection section 182, and a billing database 184. In alternate embodiments, the billing module 144 could comprise additional or alternative components.

The network element managers area 84 generally comprises a command mediation and network and platform managers. The command mediation area is coupled to the service provisioning module 140 and includes a voice mediation section 186, an Internet services section 188, and a video section 190. The network and platform managers area is coupled to the service assurance module 142 and includes an access network managers section 192, a voice switch managers section 194, and H/E managers section 196, a data network manager section 198, and a service manager and servers manager section 200. The network element managers area 84 for the comprises a voice mediation section 202, an Internet section 204 and a video section 206 which are coupled to the billing module 144.

The network elements service platform 86 generally comprises a CPE section 208, an access networks section 210, a head end and switching section 212, a core networks section 214, a service platform section 216 and an external service access section 218. In alternate embodiments, the network elements service platform 86 could comprise additional or alternative components.

The system shown in FIG. 8 further comprises a service allocation module 220 and a network provisioning module 222. The two modules 220 and 222 are operably coupled to the EAI 116. The service allocation module 220 comprises a capacity requester section 224 and a service inventory database 226. The network provisioning module 222 comprises a network inventory section 228, an access network planning and design section 230, a data network planning and design section 232 and a network inventory/Net master catalog/network plan/forecast database 234. In alternate embodiments, the service allocation module and the network provisioning module could comprise additional or alternative components.

For the system shown in FIG. 8, the following table is an example of types of software which can be used with the various different sections. It should be noted, however, that in alternate embodiments any suitable type of software could be used.

| Section Number | Software |
|---|---|
| 94 | CTI ™, ACD ™, IVR ™, Fax |
| | Manager ™, ClearCallCenter ™ |
| 96 | EFrontOffice ™ |
| 98 | ClearSales ™ |
| 100 | ClearContracts ™ |
| 102 | ClearLogistics ™ |
| 104 | ClearLogistics ™ |
| 106 | ClearSupport ™ |
| 118 | * |
| 120 | Prime ™, @Vantage ™ |
| 122 | SAS ™ |
| 124 | Oracle WH ™ |
| 126 | Oracle Express (Hyperion |
| | EssBase) ™ |
| 128 | Business Object (Brio 1) |
| 130 | Oracle GL ™, Oracle AP ™, |
| | Oracle AR ™, Oracle FA ™ |
| | Oracle HR ™, Oracle IC ™, |
| | Projects ™ |
| 132 | Docushare ™ |
| 134 | ClickSchedule ™ |
| 146 | ASAP ™ |
| 147 | JR-APS ™ |
| 148 | Vitria BW connector ™ |
| 156 | Netcool/ISM ™ |
| 158 | Metrica ™ |
| 160 | ClearSupport ™ |
| 162 | NetCool ™ |
| 168 | Arbor/BP ™ |
| 170 | Doc1 ™ |
| 172 | IXBS (Interconnect) ™ |
| 174 | Arbor/BP A/R ™ |
| 176 | Actuate ™ |
| 178 | Xacct ™, and * |
| 180 | TBD ™ |
| 182 | Comptel ™ |
| 186 | ** |
| 188 | Cisco SRC ™ |
| 190 | Conditional Access Servers ™ |
| 192 | ** |
| 194 | ** |
| 196 | ** |
| 198 | Cisco Works HPQV ™ |
| 200 | BMC Patrol ™ |
| 224 | * |
| 228 | SmallWorld ™ |
| 230 | SmallWorld ™ |
| 232 | Netsys ™ |

*-Custom software
**-Vendor specific software

The Clarify™ Software is a customer relationship Management (CRM) product owned by a Nortel Networks. Clarify is used as an order entry customer service/workflow application. It is the primary interface between the customer and the service provider. Therefore, all the customer information is stored in Clarify and the customer processes are managed by Clarify.

ClickSchedule™ is a scheduling tool developed by IET. ClickSchedule manages the availability of the engineers and technicians. It keeps track of the free installation time slots and optimizes the agenda of the technicians to maximize their availability. It interfaces with Clarify to enable booking of installations for a customer when taking an order.

Arbor/BP™ is a billing software product owned by Lucent. Arbor/BP handles both billing and accounts receivable. It is the module which brings together the usage, the customer and the tariff information and creates the bills from these inputs.

Doc1™ is a document design and formatting tool developed by a Group 1. Doc1 is used to print the bills in PDF format.

Product Organizer is a custom developed central product repository. It guarantees that the product information is consistent across applications. Product Organizer is used as the central database for product definitions.

Capacity Requester is a custom network and service capacities solution developed by Accenture. Capacity Requester stores the logical view of the network, and services deliverable at the client location. It provides customer addresses management, households and service readiness management, topology management (light network inventory for critical provisioning data only), and capacity management for telephone, Internet and television networks.

ASAP™ (automated service activation program) is a provisioning Product owned by a Nortel Networks. ASAP interfaces with the network elements to provision orders for telephone products. ASAP interfaces with Clarify to handle fully automated flow through provisioning.

Comptel is a usage mediation software product developed by Comptel. Comptel handles the usage mediation for the telephone network. It is an automated tool that has no users. It is interfaced with Arbor/BP to provide the usage information for billing.

Vitria is used as the enterprise application integration package. Vitria automates the interfaces for several business processes (e.g., customer and contract set up, dunning and collections, automated provisioning, etc.). Vitria provides capabilities for both batch and real-time inter-application communication. The technology is based on a “publish and subscribe” concept. It provides functionality for data mapping and transformation. Easy integration between the different software packages through Vitria is possible through an existing set of leading software packages adapters (Arbor/BP, Clarify eFrontOffice, ARS Remedy, Oracle financials, etc.).

Actuate™ is a reporting tool to generate reports on customer accounts (billing, collections and dunning), and on market information, and to produce statistics on the service providers business (products, customers, etc.) In an alternate embodiment, Actuate could be replaced by Brio™.

Although various different types of specific software have been described above, any suitable type of software, which can perform the same functions, could be used.

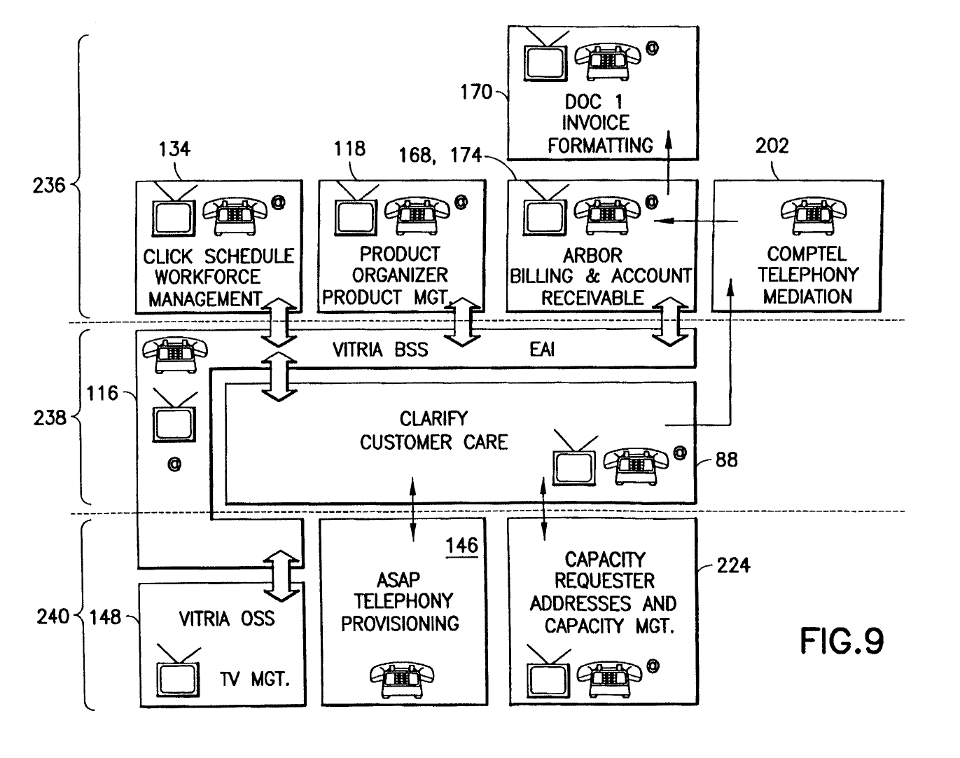

Referring now to FIG. 9, a block diagram of a software application architecture component overview of the system shown in FIG. 8 incorporating features of the present invention is shown. The system generally shown in an operational organized breakdown of a back office section 236, a customer care section 238, and network provisioning and operations section 240. The main components of the back office section 236 comprises the workforce management section 134, the product management section 118, the billing and accounts receivable sections 168, 174, the invoice formatting section 170, and the telephone mediation section 202.

The workforce management section 134 preferably comprises ClickSchedule™ software. However, in alternate embodiments, any suitable type of software could be used. The workforce management section 134 is adapted to schedule and manage the employee work force of the supplier for all the telecommunications systems including, in the embodiment shown, television, telephone and Internet service. The ClickSchedule™ software in the workforce management section 134 is operably coupled to the Vitria™ BSS software in the EAI.

The product management section 118 preferably comprises Product Organizer software. However, in alternate embodiments, any suitable type of software could be used. The product management section 118 is adapted to maintain an inventory, description and management of products supplied by the supplier to the customer. In the embodiment shown, the product management section 118 is adapted to include products in the television, telephone and Internet service area. The Product Organizer software in the product management section 118 is operably coupled to the Vitria™ BSS software in the EAI.

The billing section 168 and accounts receivable section 174 preferably comprise Arbor™ software. However, in alternate embodiments, any suitable type of software could be used. The billing section and accounts receivable section 168, 174 are adapted to formulate customer bills and track accounts receivable. The billing section and accounts receivable section 168, 174 use the Arbor™ software for all three telecommunications services; television, telephone and Internet. The Arbor™ software in the billing and accounts receivable sections 168, 174 is operably connected to the Vitria™ BSS software in the EAI.

The invoice formatting section 170 preferably comprises Doc1™ software. However, in alternate embodiments, any suitable type of software could be used. The invoice formatting section 170 is adapted to format and print invoices based upon input from the billing and accounts receivable sections. The invoice formatting section 170 uses The Doc1™ software for all three telecommunications services; television, telephone and Internet. The Doc1™ software in the invoice formatting section 170 is operably connected to the Arbor™ software accounts receivable section 168, 174.

The telephone mediation section 202 preferably comprises Comptel™ software. However, in alternate embodiments, any suitable type of software could be used. The telephone mediation section 202 is used to track telephone communications between customers and the supplier. Information input into the Comptel™ software of the telephone mediation section 202 can be input into the Arbor™ software in the billing and accounts receivable sections 168, 174. In the embodiment shown, the Comptel™ software in the telephone mediation section 202 is directly connected to the Clarify™ software in the customer care section 88.

The customer care section 238 preferably comprises the EAI 116 and the customer care module 88. The EAI 116 preferably comprises Vitria™ BSS software. However, in alternate embodiments, any suitable type of EAI software could be used. The Vitria software allows the various different software packages to communicate with each other. The Vitria™ BSS software operably connects the ClickSchedule™ software, Product Organizer software, Arbor™ software, Clarify™ software, and Vitria™ OSS software in the network provisioning and operations section to each other. The Vitria software in the EAI 116 is used to transmit information regarding telephone, television and Internet delivery service provided by the supplier.

The customer care module 88 preferably comprises Clarify™ software. However, in alternate embodiments, any suitable type of software could be used. The Clarify software is used to manage and track issues regarding customer care, such as customer profile information, service orders, and service requests. The Clarify™ software is operably connected to the EAI 116. Thus, the customer care module 88 is operably connected, through the EAI 116, to the software in the work management section 134, the product management section 118, the billing and accounts receivable sections 168, 174, and the television management section 148. The customer care module 88 and the Clarify software is adapted to provide customer care for all three telecommunications delivery services; television, telephone and Internet.

The network provisioning and operations section 240 includes the television management section 148, the telephone provisioning section 146, and the addresses and capacity management section 224. The television management section 148 preferably comprises Vitria™ OSS software. However, in alternate embodiments, any suitable type of software could be used.

The telephone provisioning section 146 preferably comprises ASAP™ software. However, in alternate embodiments any suitable type of software could be used. The ASAP™ software is operably connected to the Clarify™ software in the customer care module 88. The ASAP™ software is adapted to track and manage provisioning of telephone delivery services.

The addresses and capacity management section 224 preferably comprises Capacity Requester software. However, in alternate embodiments, any suitable software could be used. The Capacity Requester software is operably connected to the Clarify software in the customer care module 88. The Capacity Requester software is adapted to track and manage addresses and service capacities of all three telecommunications delivery services; television, telephone and Internet.

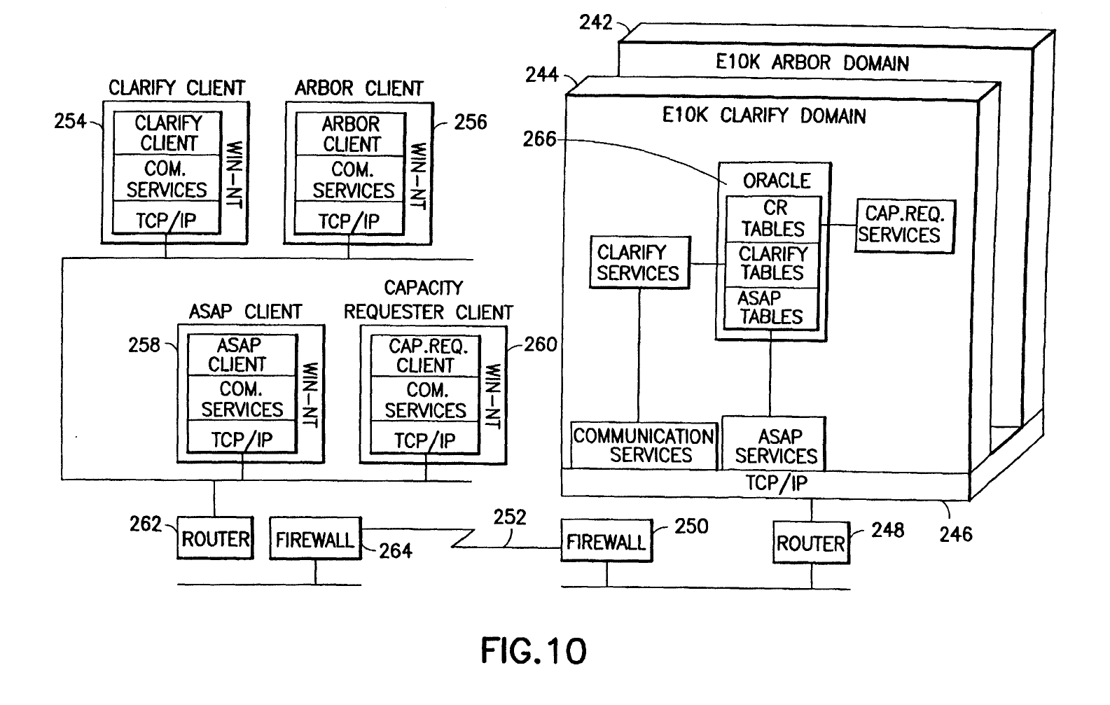

Referring now also to FIG. 10, a block diagram of the technical architecture for the application architecture shown in FIG. 9 is shown. The system preferably comprises a domain 242 for the Arbor™ software and a domain 244 for the Clarify™ software. In the embodiment shown, each domain 242, 244 is provided in a separate server, such as an E10K server. The servers 242, 244 are connected by a TCP/IP 246, router 248 and firewall 250 to a high speed Internet connection 252. A remote location can comprise a Clarify™ client 254, an Arbor™ client 256, an ASAP™ client 258 and a Capacity Requester client 260 which are connected to the high-speed Internet connection 252 by a router 262 and firewall 264.

The four clients 254, 256, 258, 260 comprise use of Windows NT operating system software. However, in alternate embodiments, any suitable type of operating system could be used. The Clarify™ client comprises Clarify™ client software, communications service software, and TCP/IP software. The Arbor™ client 256 comprises Arbor™ client software, communications service software, and TCP/IP software. The ASAP™ client 258 comprises ASAP™ client software, communications service software, and TCP/IP software. The Capacity Requester client 260 comprises Capacity Requester client software, communications service software, and TCP/IP software. In alternate embodiments, the clients could comprise any suitable type of client software adapted to function with the software located on the domain servers 242, 244.

The domain server 244, which forms the domain for the Clarify™ software, preferably comprises sections for the communication services software, Clarify™ services, ASAP™ services, Capacity Requester services, and other services such as in the Enterprise Support System (ESS) module 92. In the embodiment shown, this other section 266 comprises use of Oracle™ software with Capacity Requester tables, Clarify™ tables, and ASAP™ tables.

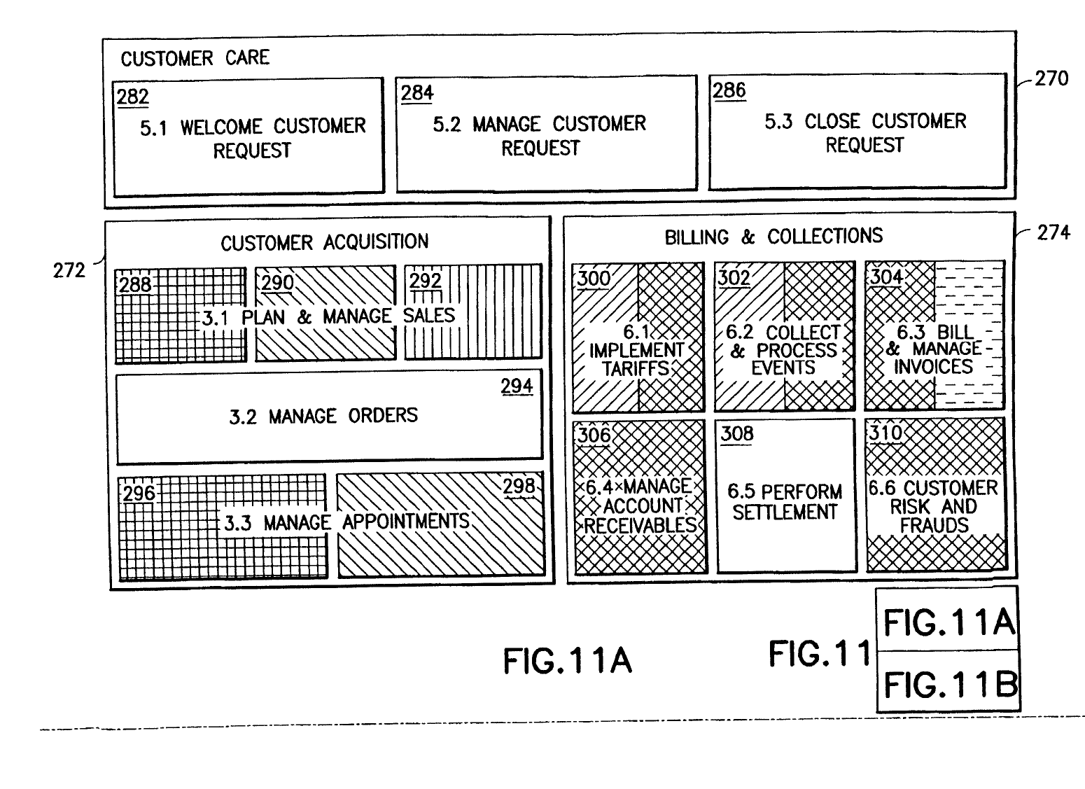

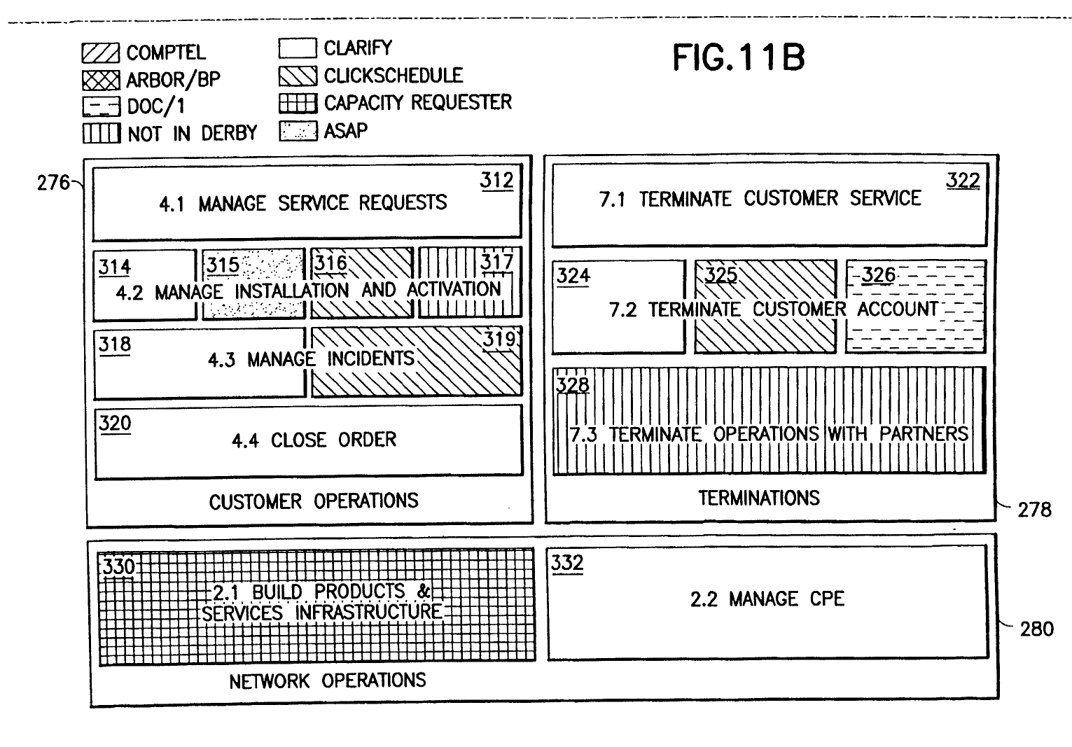

Referring now also to FIG. 11, a diagram of process architecture and preferred software for the system of FIG. 8 is shown. The process architecture generally comprises a customer care section 270, a customer acquisition section 272, a billing and collections section 274, a customer operations section 276, a termination section 278, and a network operations section 280. The customer care section 270 comprises a welcome customer request section 282, a manage customer request section 284, and a close customer request section 286. These three sections 282, 284 and 286 all comprise use of Clarify™ software.

The customer acquisition section 272 generally comprises three plan and manage sales sections 288, 290, 292, a manage orders section 294 and two manage appointments sections 296, 298. The first plan and manage sales section 288 comprises use of Capacity Requester software. The second plan and manage sales section 290 comprises use of ClickSchedule™ software. The third plan and manage sales section 292 comprises use of either a custom or vendor supplied software. The manage orders section 294 comprises use of the Clarify software. The first manage appointments section 296 comprises use of the Capacity Requester software and the second manager appointments section 298 comprises use of the ClickSchedule™ software.

The billing and collections section 274 comprises an implement tariffs section 300, a collect and process events section 302, a bill and manage invoices section 304, a manage accounts receivable section 306, a perform settlements section 308 and a customer risk and frauds section 310. The implement tariffs section 300 comprises use of the Comptel™ software and the Arbor/BP™ software. The collect and process events section 302 comprises use of the Comptel™ software and the Arbor/BP™ software. The bill and manage invoices section 304 comprises use of the Arbor/BP™ software and the Doc1™ software. The manage accounts receivable section 306 comprises use of the Arbor/BP™ software. The perform settlement section 308 comprises use of the Clarify™ software. The customer risk and frauds section 310 comprises use of the Arbor/BP™ software.

The customer operations section 276 generally comprises a manage service requests section 312, four manage installation and activation sections 314, 315, 316, 317, to manage incidence sections 318, 319, and a close order section 320. The manage service requests section 312 comprises use of the Clarify software. The four managed installation and activation sections 314-317 comprise use of Clarify™, ASAP™, ClickSchedule™ and another software application, such as custom or vendor supplied, respectively. The two manage incidence sections 318, 319 comprise use of the Clarify™ software and the ClickSchedule™ software, respectively. The close order section 320 comprises use of the Clarify™ software.

The terminations section 278 generally comprises a terminate customer service section 322, three terminate customer account sections 324, 325, 326, and a terminate operations with partners section 328. The terminate customer service section 322 and the first terminate customer account section 324 comprise use of the Clarify™ software. The second and third terminate customer account sections 325, 326 comprise use of the ClickSchedule™ software and the Doc1™ software, respectively. The terminate operations with partners section 328 comprises use of other software, such as vendor supplied software or a custom software.

The network operations section 280 generally comprises a build products and services infrastructure section 330 and a manage CPE section 332. The build products and services infrastructure section 330 preferably comprises use of the Capacity Requester software, and the manage CPE section 332 comprises use of the Clarify™ software.

FIG. 11 helps to illustrate the use of the various different types of softwares in the various different types of system processes. Because most of the software is easily adapted to use with the Vitria EAI package software, the various sections can be operably connected to each other for sharing information and operably coupling different types of systems to each other, such as operably coupling different types of telecommunications systems to each other or operably coupling different country service divisions or companies in different countries to each other.

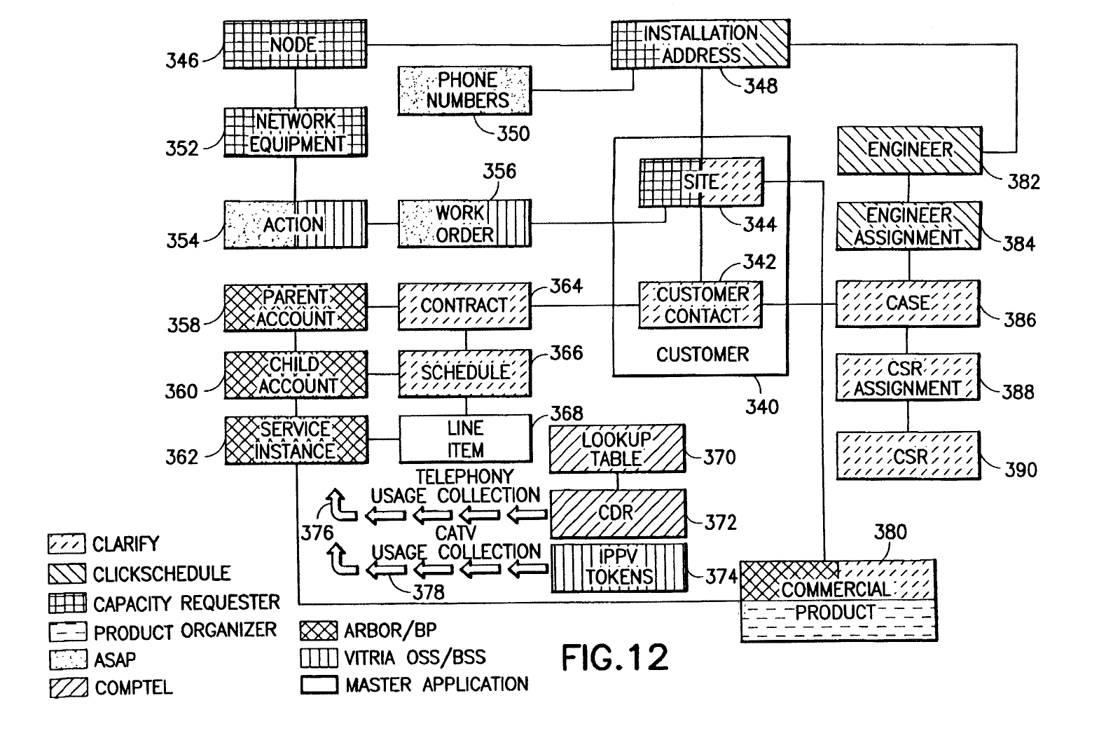

Referring now also to FIG. 12, a diagram of primary or key data objects, along with the preferred softwares, for the system of FIG. 8 is shown. The key data objects refer to a meta-conceptual data level. The diagram provides some highlights of the general concepts of the present invention, but is not a fully accurate representation of the data model. The solution provided by the present invention is driven by business objectives. Therefore, the central element in the present invention is the customer. The data objects include a customer 340, a customer contact 342 of the customer 340, a site 344 of the customer 340, a node 346, an installation address 348, phone numbers 350, network equipment 352, an action 354, a work order 356, a parent account 358, a child account 360, a service instance 362, a contract 364, a schedule 366, a line item 368, a lookup table 370, a CDR 372, IPPV tokens 374, telephone usage collection 376, television usage collection 378, commercial products 380, an engineer 382, an engineer assignment 384, a case 386, a CSR assignment 388, and a CSR 390.

Every person who has been in contact with the service provider is called a “contact”. A contact is assigned a specific role to a “site”. A site is a place where the service provider provides services or where contacts have been registered. A cite can be identified by the postal address. Several contacts can be assigned to the same site. A site can be connectable or not. A “customer” is defined by the combination of contact and site. “Customer” is a generic term that covers the different roles that a person can have for the service provider: a client can be a prospective customer, or a customer of one or more services with one or more invoices.

An “installation address” is an address where the service provider provides services. Information on the kind of services, capacity, and other technical information, is stored in the Capacity Requester database. The information is requested through Clarify at the moment of an installation request. ClickSchedule needs the information for scheduling an installation by an engineer. Note that a site can have several installation addresses. A customer can also have several installation addresses. An address can only be updated when the contact is still a prospect. Once he is a customer, the procedure for moving then needs to be applied.

“Site parts” in Clarify (not displayed) are products (e.g. phone line, phone number display, etc.) that have been actually installed. Site parts are linked to a contract. They can only be removed from a contract by following the service deletion procedure.

“Commercial products” are registered in Product Organizer. This is the master database for all commercial product related information in Clarify and Arbor.

Activation, triggered in Clarify, is done automatically by creating the necessary work order and automatically executed related actions in ASAP (for telephone), or feature (for cable television).

A “contract” in Clarify groups the customer information (invoice address, payment method, banking information, services provided to be given customer). A contract is created by the system at the moment of the first order, which means once the quotation has been validated, and the products have been correctly installed. A contract groups all customer accounts that are being invoiced to a customer. A customer only has one contract.

A “schedule” in Clarify represents a billed account. Its stores both billing information (payment method, a list of services, etc.), and accounts receivable (balance, etc.) information. A schedule has multiple lines that represent the individual charges, billed under that schedule.

A contract of the customer is linked to a “parent account” in Arbor. Accounts in Arbor are defined as billable entities, which receive invoices for products and services used. Information related to an account is the balance, discounts, installed products, etc., for a given customer. Accounts are organized in a hierarchical matter of one parent and one or more “Child Accounts”, to provide the flexibility in billing the customer according to his requirements (e.g. triple play: one child account covers all services, or three Child Accounts are defined for the parent account of a customer). The child account in Arbor corresponds to the schedule in Clarify, which a line item in Clarify is linked to a service instance (telephone, Internet, digital TV), and related product elements in the Arbor.

A “service instance” represents the network equipment (identified by a unit unique external identifier: phone number, serial number, MAC address), used to generate usage. A service instance can have several product elements related to it. A “product element” is used to apply charges (recurring or usage).

Call Detail Records (CDRs), which contain telephone usage information for both business and residential customers, are processed by Comptel. CDRs from residential customers are then loaded in the Arbor for billing. CDRs from business customers can be forward to Saville (Business telephone billing application). Interconnect CDRs can be forwarded to IXBS in a remote location.

Interactive pay-per-view (IPPV) tokens, which contain CATV usage information, can be processed by Vitria, and loaded in Arbor for billing.

All customer and prospect interactions can be registered in Clarify. An interaction can be a request for administrative information or technical resolution, which results in the creation of a case in Clarify, that is added to a queue of a service provider department. The cases in the queue need to be assigned to the right individual (the “owner” of the case), until the case is resolved. It can also be an order for a product or service, resulting in a queue, and automatically generated part request, in which case Capacity Requester is consulted to verify available capacity.

Interactions may require intervention by an engineer. If this is the case, Clarify posts a request to ClickSchedule to book an engineer. Based on the parameters that relate to the nature of the activity (what skills are needed), the location of the customer (searching for an engineer in that area), and availability of an engineer that meets the given requirements, ClickSchedule assigns an engineer to the case, and reports it back to the CSR who can make an appointment with the contact.

For the embodiment shown in FIG. 8, the Clarify™ software is used with the contract data object 364, the schedule data object 366, the line item data object 368, the site data object 344, the installation address object 348, the case data object 386, the CSR assignment data object 388, the CSR data object 390 and the commercial product data object 380. The ClickSchedule™ software is used with the installation address data object 348, the engineer data object 382, and the engineer assignment data object 384. The Capacity Requester software is used with the node data object 346, the phone numbers data object 350, the network equipment data object 352, the installation address data object 348, and the site data object 344. The Product Organizer software is used with the commercial product data object 380. The ASAP™ software is used with the action data object 354 and the work order data object 356. The Comptel™ software is used with the lookup table data object 370 and the CDR data object 372. The Arbor/BP™ software is used with the customer data object 340 and with the telephone usage collection data objects 376 and television usage collection data objects 378. The Vitria™ software is used with the action data object 354, the work order object 356, and the IPPV Tokens 374. As noted above, although specific types of commercially available software is being described with reference to the embodiment shown in FIG. 8, features of the present invention could be used with any suitable type of software which accomplishes the same function as the commercially available software packages used herein for a description of the invention.

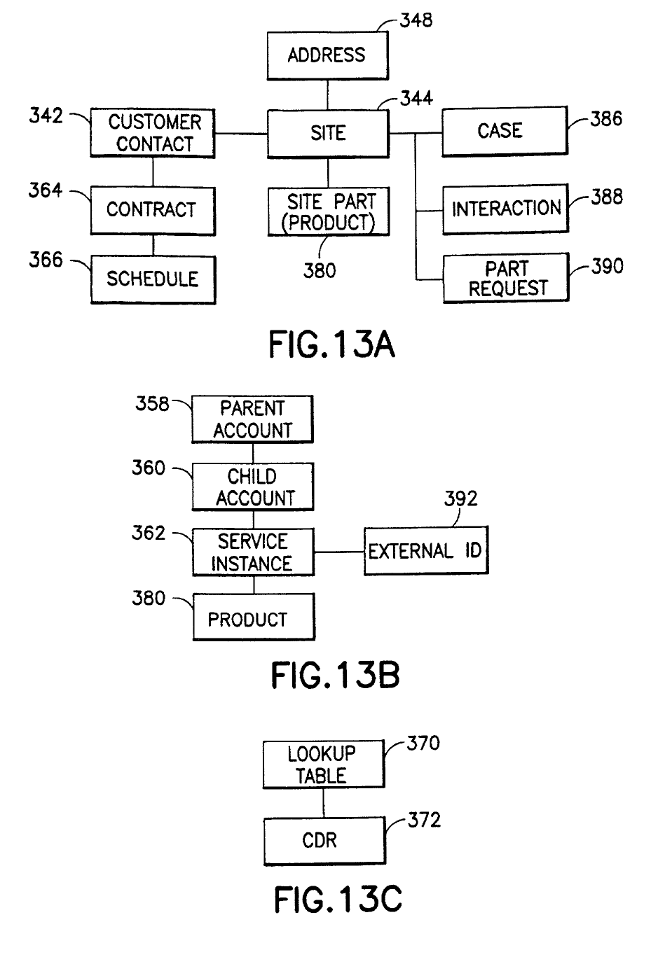

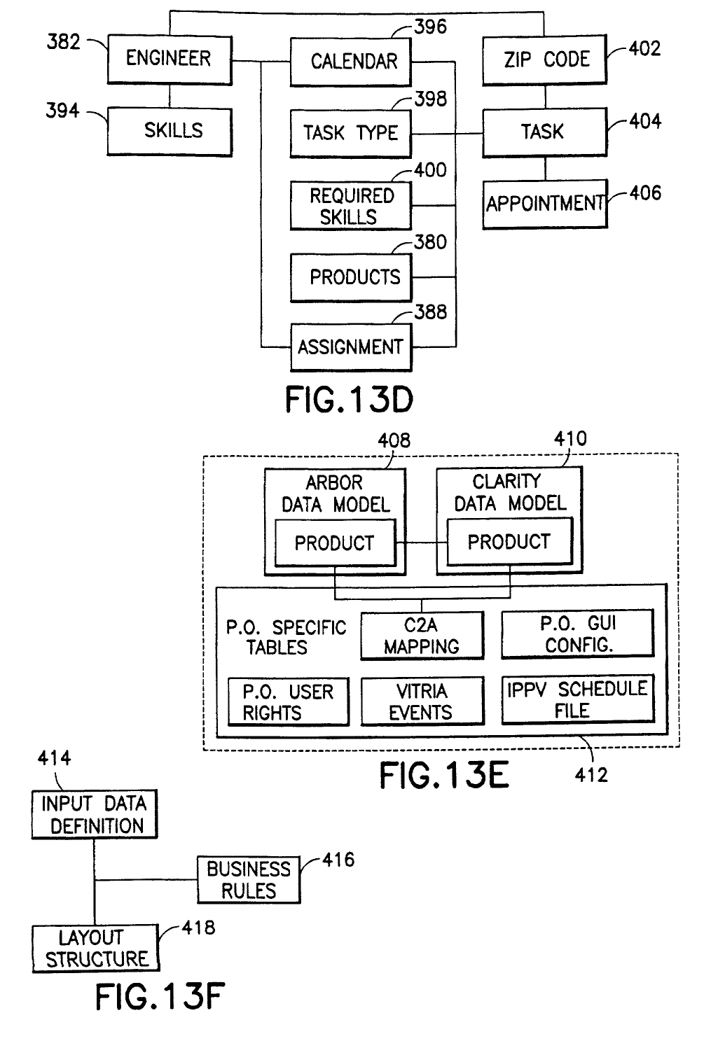

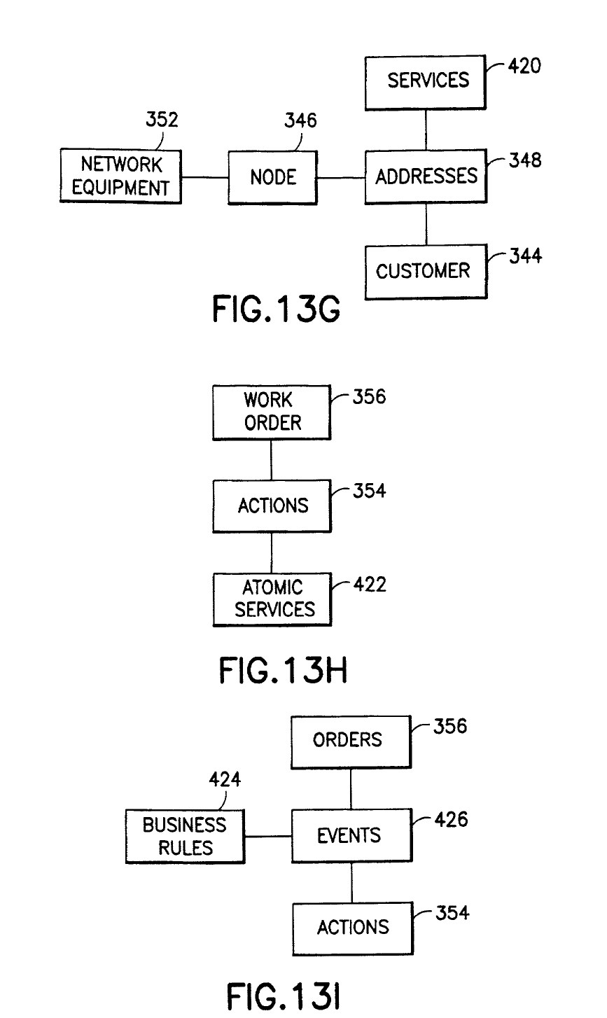

Referring now to FIGS. 13A-13I, primary or key software data objects for use with the present invention relative to the various commercially available software packages referenced with regard to FIGS. 8-12 will be described. FIG. 13A is a block diagram of data objects used with the clarify™ software. The data objects include the address data object 348, the site data object 344, the site part data object 380, the case data object 386, the interaction data object 388, the part request data object 390, the customer contact data object 342, the contract data object 364 and the schedule data object 366. FIG. 13B is a block diagram of the objects used with the Arbor/BP™ software. The data objects include the parent account data object 358, the child account data object 360, the service instance data object 362, the product data object 380 and an external ID data object 392. FIG. 13C is a block diagram of the objects used with the Comptel™ software. The data objects include the lookup table data object 370 and the CDR data object 372. FIG. 13D is a block diagram of the objects used with the ClickSchedule™ software. The data objects include the engineer data object 382, an engineer skills data object 394, a calendar data object 396, a task type data object 398, a required skills data object 400, a products data object 380, an assignment data object 388, and address zip code data object 402, a task data object 404 and an appointment data object 406. FIG. 13E is a block diagram of data objects used with the Product Organizer software. The data objects include an Arbor Data model 408 with a product data object, a clarify data model 410 with a product data object, and purchase order specific tables 412 with a C2A mapping data object, a purchase order GUI configuration data object, a purchase order user rights data object, a Vitria™ events data object, and an IPPV schedule file data object. FIG. 13F is a block diagram of data objects used with the Doc1™ software. The data objects include an input data definition data object 414, a business rules data object 416 and a layout structure data object 418. FIG. 13 G is a block diagram of data objects used with the Capacity Requester software. The data objects include the network equipment data object 352, the node data object 346, the address data object 348, the site data object 344 of the customer data object 340, and a services data object 420. FIG. 13H is a block diagram of data objects used with the ASAP™ software. The data objects include the work order data object 356, the action data object 354, and an atomic services data object 422. FIG. 13I is a block diagram of data objects used with the Vitria™ software. The data objects include the work order data object 356, the action data object 354, a business rules data object 424, and an events data object 426. In alternate embodiments, the various different types of softwares can be used with any suitable type of data objects.

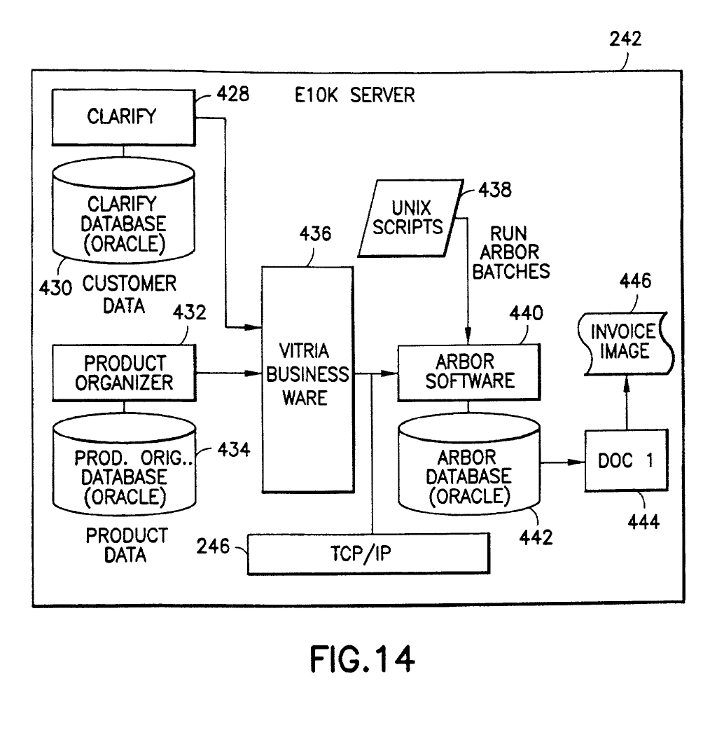

Referring now to FIG. 14, a block diagram of one type of execution architecture for the Arbor™ software is shown. In alternate embodiments, any suitable type of execution architecture could be used. The execution architecture is located on the server 242. The execution architecture generally comprises the Clarify™ software 428, a Clarify™ database 430 for holding customer data, the Product Organizer software 432, a Product Organizer database 434 for storing product data, the Vitria™ Businessware software 436, the TCP/IP software 246, Unix™ scripts 438, Arbor™ software 440, Arbor™ database 442, Doc1™ software 444, and an invoice image system 446. However, in alternate embodiments, any suitable type of execution architecture for the Arbor/BP™ software, or equivalent software, could be provided.

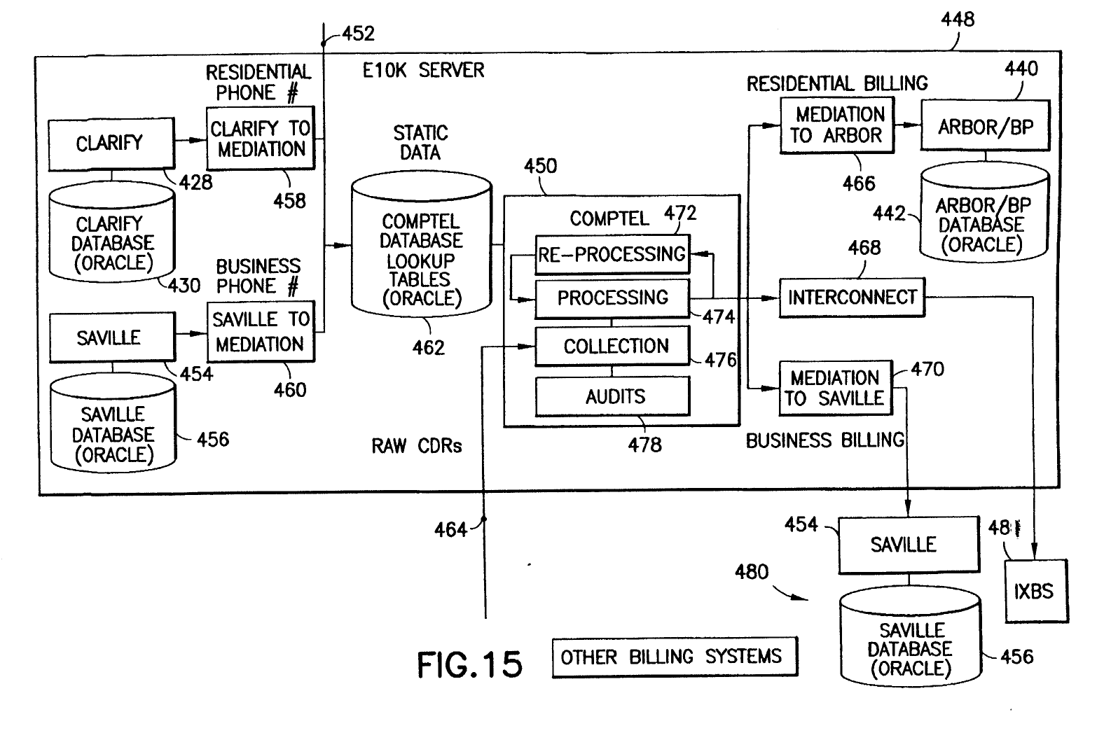

Referring now to FIG. 15, a block diagram of one type of execution architecture for the Comptel™ software is shown. The Comptel™ software 450 is located on a server 448 which could comprise the server 242 or server 244. Alternatively, the server 248 could be connected to another server by the connection 452, such as via the Internet or a high speed telecommunications connection. The architecture comprises the Clarify™ software 428 the Clarify™ database 430, a Saville™ software package 454, a Saville database 456, Clarify to Mediation software 458, Saville to Mediation software 460, a database of Comptel™ look up tables 462, and input 464 for raw CDRs, Mediation to Arbor Software 466, interconnect software 468, Mediation to Saville software 470, Arbor/BP™ software 440, and an Arbor/BP database 442.

The Comptel™ software 450 comprises reprocessing software 472, processing software 474, collection software 476 and audits software 478. An output from the mediation to Saville™ software 470 can be connected to other billing systems 480 which comprise Saville™ software 454 and a Saville database 456. The output from the interconnect software 468 can be connected to an IXBS 481. in alternate embodiments, the Comptel execution architecture might not be connected to other billing systems. In other alternate embodiments, any suitable type of execution architecture could be provided for the Comptel™ software or equivalent software.

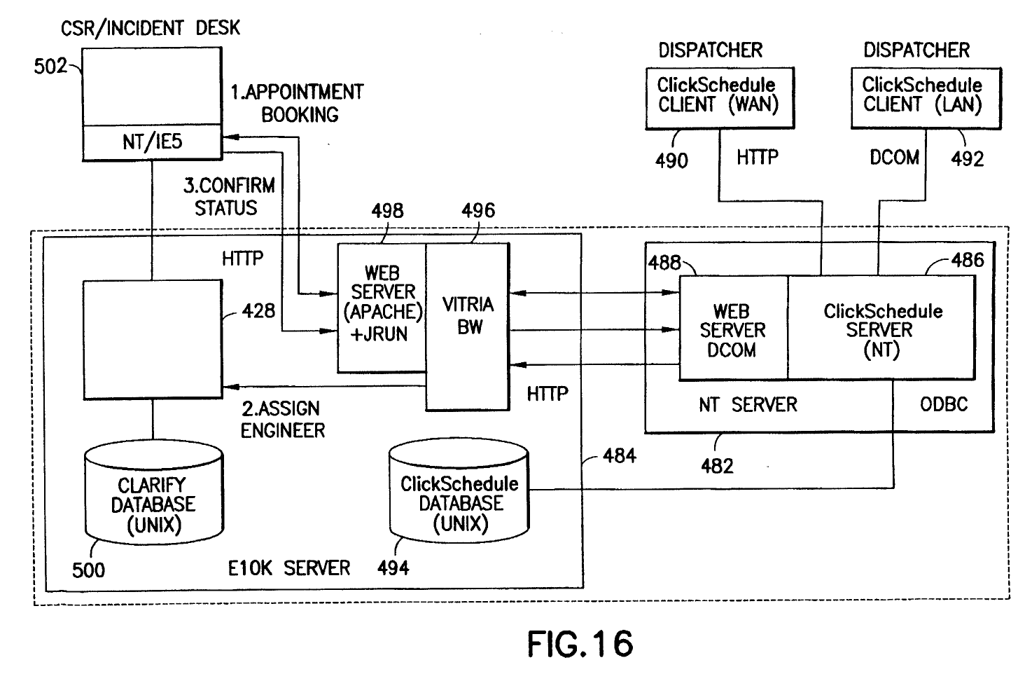

Referring now to FIG. 16, a block diagram of one type of execution architecture for the ClickSchedule™ software is shown. The architecture generally comprises a first server 482 and a second server 484. The second server 44 could comprise one of the servers 442, 444. The first server 448 comprises ClickSchedule™ Server (NT) software 486, and Web server software 488. The ClickSchedule server software 486 can be connected to dispatchers 490, 492 comprising ClickSchedule client software on a network (WAN or LAN) through HTTP or DCOM connections.

The ClickSchedule server software 486 is connected to the ClickSchedule database 494 on the server 484. The second server 484 further comprises the Vitria™ BusinessWare software 496, Web Server™ (Apache) and JRUN™ software 498, a clarify database 500, and clarify software 428. A CSR/incident desk 502 is operably connected to the Clarify™ software 428 and the Web Server™ (Apache) and JRUN software 498. The Web software 498 is used with the desk 502 for appointment bookings and status confirmation of bookings. The Vitria BW software 496 is used with the clarify software 428 for an engineer assignment. In alternate embodiments, any suitable type of execution architecture could be provided for the ClickSchedule™ software or equivalent software.

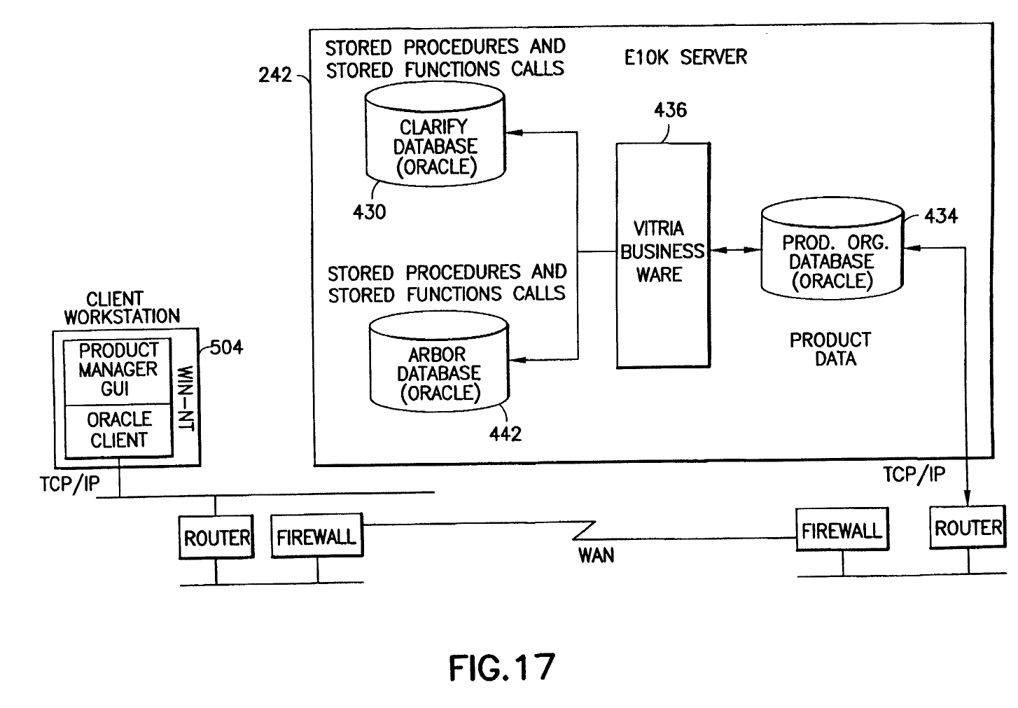

Referring now to FIG. 17, a block diagram of one type of execution architecture for the Product Organizer software is shown. The execution architecture comprises a server 242, which could comprise one of the aforementioned servers. Located on the server 242 is the Vitria™ BusinessWare software 436, the Arbor™ database 442, the clarify database 430, and the Product Organizer database 434. The execution architecture includes a client workstation 504 connected to the server 242. The client workstation 504 comprises Product Manager™ GUI software and Oracle™ client software. The connection between the client workstation 504 and the server 242 allows the client workstation to be connected to the Product Organizer database 434. In alternate embodiments, any suitable type of execution architecture for the Product Organizer software or equivalent software could be provided.

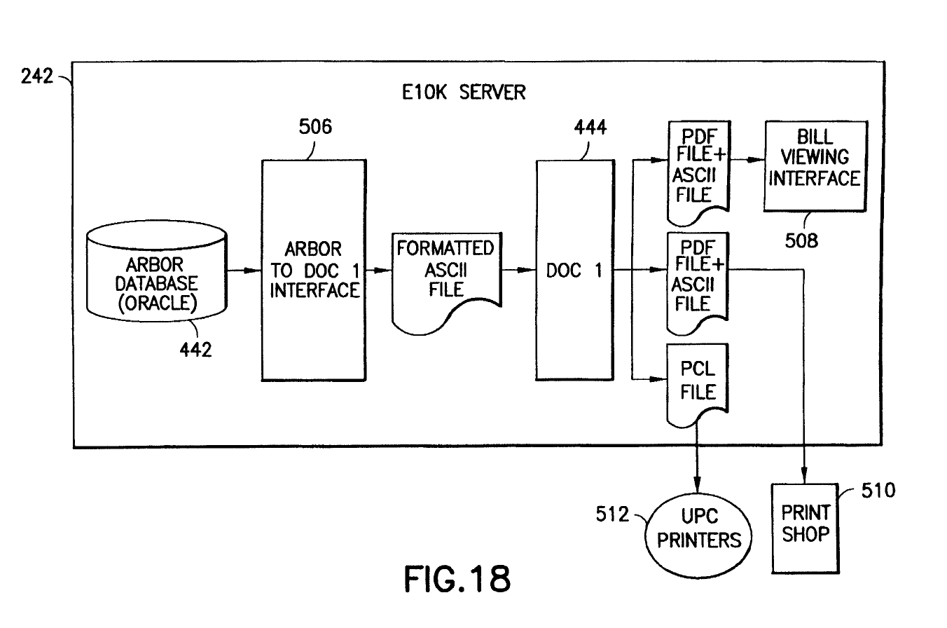

Referring now to FIG. 18, one type of execution architecture for the DOC1™ software is shown. The DOC1™ software is located on the server 242. The execution architecture includes the Arbor database 442, an Arbor to DOC1™ interface 506, and a bill viewing interface 508. The interface 506 provides a formatted ASCII file to the top one software 444. The DOC1™ software produces three outputs. A first output comprises a PDF file and ASCII file which is output to the interface 508. A second output comprises a PDF file and ASCII file which can be output to a print shop 510. A third output comprises a PCL file which can be output to a UPC printer 512. In alternate embodiments, any suitable type of execution architecture for the DOC1™ software or equivalent software could be provided.

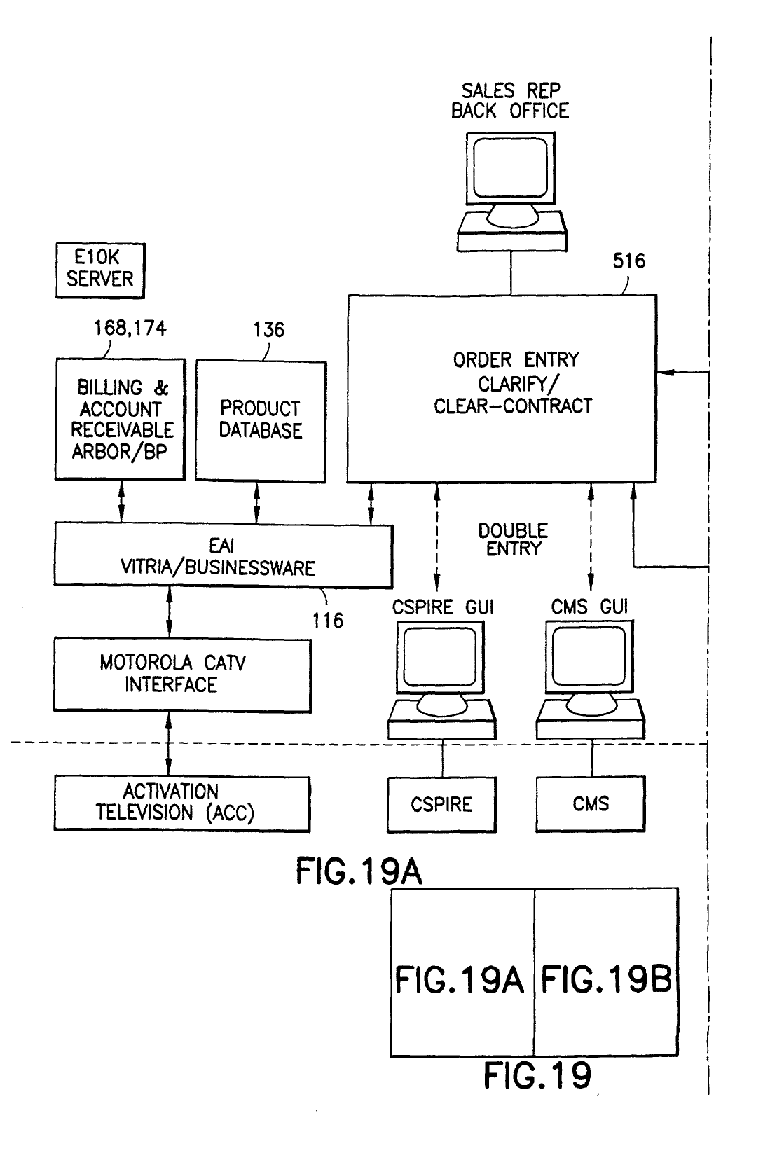

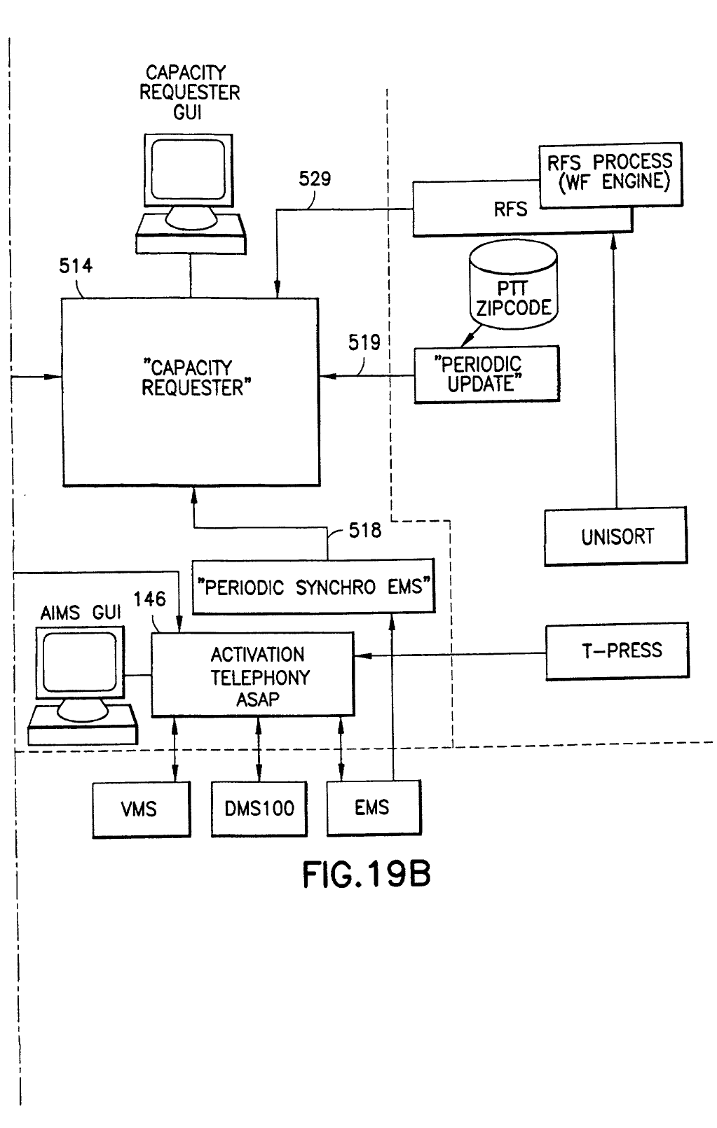

Referring now to FIG. 19, a block diagram of one type of execution architecture for the Capacity Requester software is shown. The Capacity Requester software 514 is connected to an order entry module 516 comprising the Clarify™ software and Clear-Contract™ software. The capacity requester software 514 can be updated by connections 518, 519 and 520. The order entry module 516 supplies information to the capacity requester 514 based upon input from the various other software programs as shown in FIG. 19. In alternate embodiments, any suitable type of execution architecture for the Capacity Requester software or equivalent software could be provided.

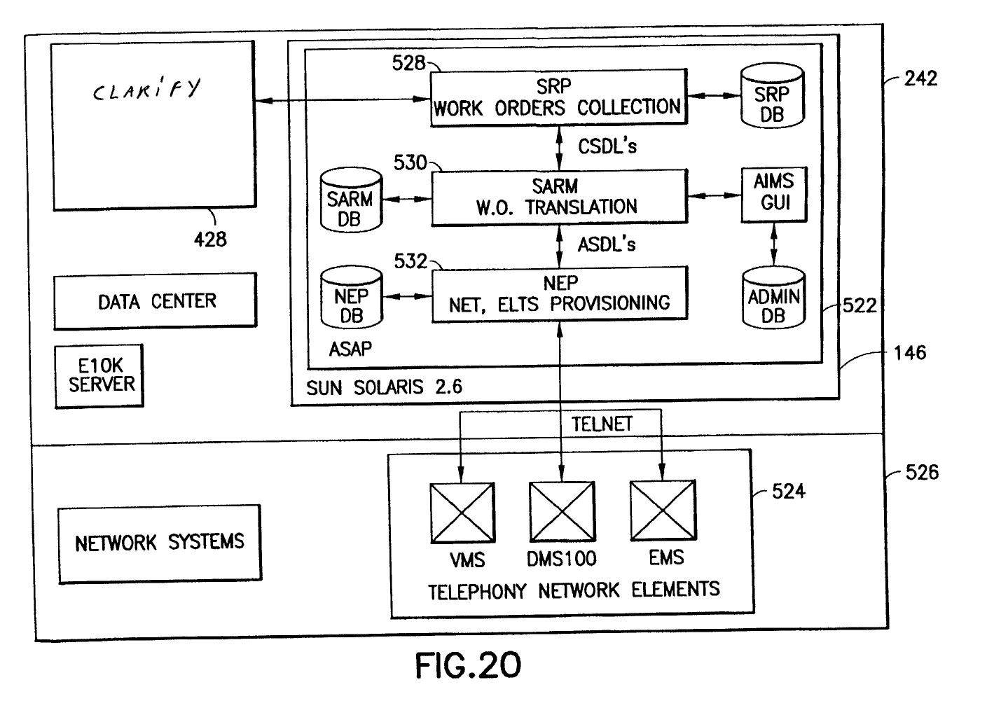

Referring now to FIG. 20, a block diagram of one type of execution architecture for the ASAP™ software is shown. In the embodiment shown, the ASAP™ software is located on the server 242. The ASAP™ software is operably connected to the clarify software 428 and to telephone network elements 524 located on a network system 526. The ASAP™ software forms various different databases and includes a work order collection section 528, a work order translation section 530, and a provisioning section 532. In alternate embodiments, any suitable type of execution architecture for the ASAP™ software or equivalent software could be provided.

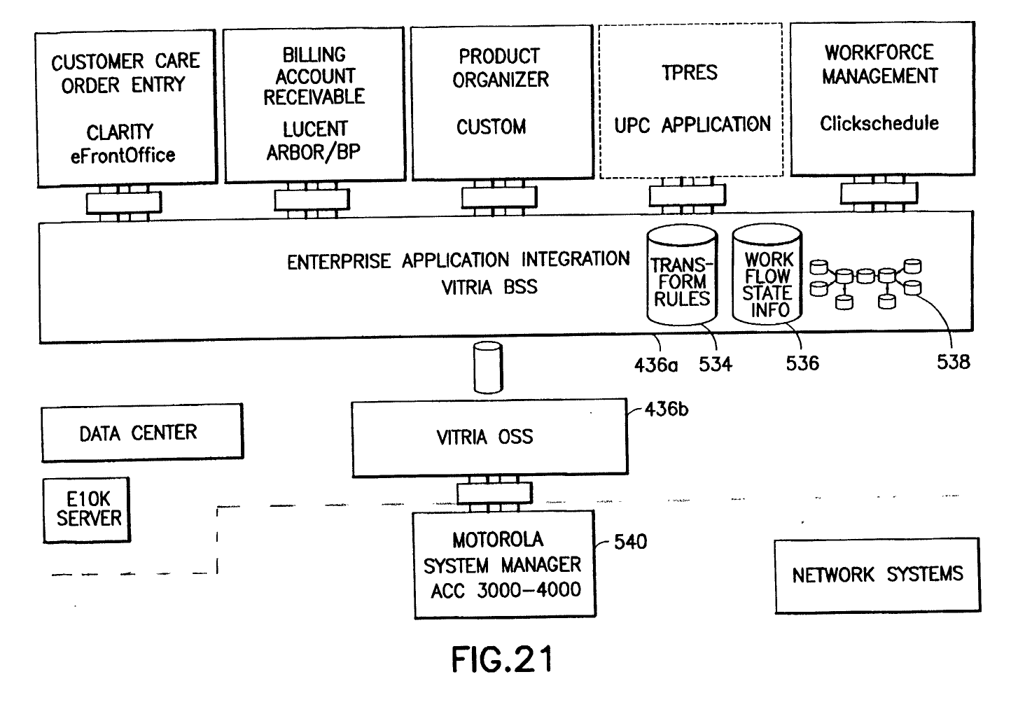

Referring now to FIG. 21, a block diagram of one type of execution architecture for the Vitria BSS software 436a is shown. The Vitria BSS software 436a is located at a data center and is connected to the Clarify™ eFrontOffice software in the customer care order entry section, the Lucent Arbor/BP™ software in the billing and accounts receivable section, custom software in the product organizer section, supplier application software in the Tpres section, ClickSchedule™ software in the workforce management section, and Vitria OSS software 436b. The Vitria BBS software forms a transform rules database 534 and a work flow state information database 536 for use by the client computers 538. The Vitria OSS software is connected to a system manager, such as a Motorola ACC 3000-4000, of a network system. In an alternate embodiment, any suitable type of execution architecture for the Vitria BSS software or equivalent software could be provided.

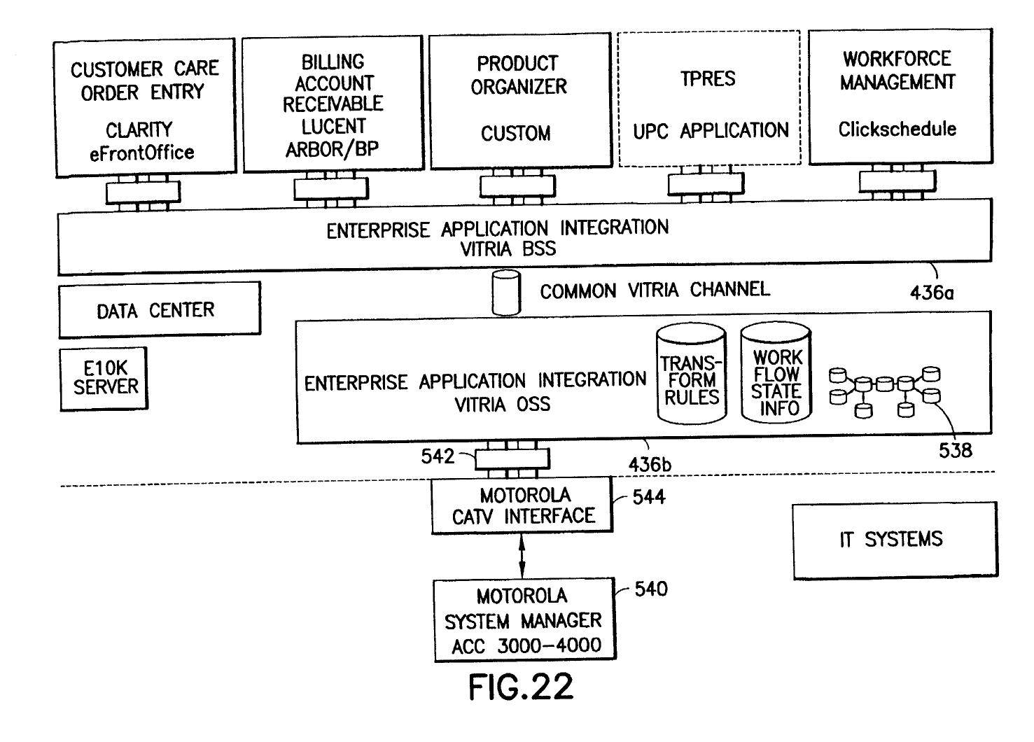

Referring now to FIG. 22, a block diagram of one type of execution architecture for the Vitria OSS software 436a is shown. The Vitria BBS software 436a is located at a data center and is connected to the Vitria BSS software 436b and to a CATV interface 544 in the system manager 540 by a synchronous Java™ connection 542. In an alternate embodiment, any suitable type of execution architecture for the Vitria OSS software or equivalent software could be provided. In an alternate embodiment, the two Vitria™ pieces (OSS and BSS) could be merged into a single piece.

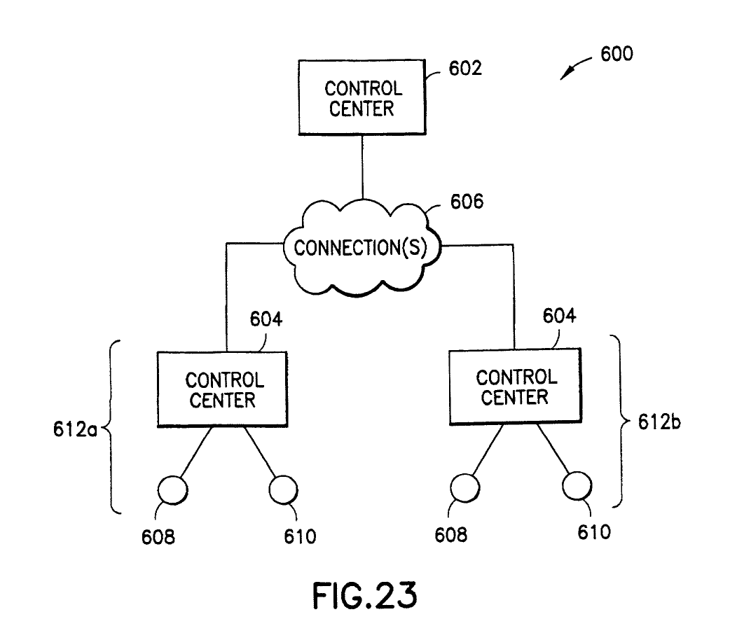

Referring now to FIG. 23, another feature of the present invention will be described. FIG. 23 is a block diagram of a system 600 which comprises a main control center 602 and a plurality of regional control centers 604. The regional control centers 604 are connected to the main control center 602 by any suitable type of connection(s) 606. The regional control centers 604 are connected to customers 608 and/or remote service locations 610. The centers 604, customers 608 and locations 610 form independently operable telecommunications service delivery companies 612a, 612b; collectively referred to as 612. In an alternate embodiment, the locations 610 could be formed integrally with the control center 604.

The companies 612 could be subsidiaries or divisions of the company which owns the main control center 602. In an alternate embodiment, the companies 612 could be licensees under the main company which owns the main control center 602. The companies 612 could provide the same type of telecommunications services, but be located in different regions, such as in different countries. The companies 612 could also provide different types of telecommunications services and be located in a same region or country.

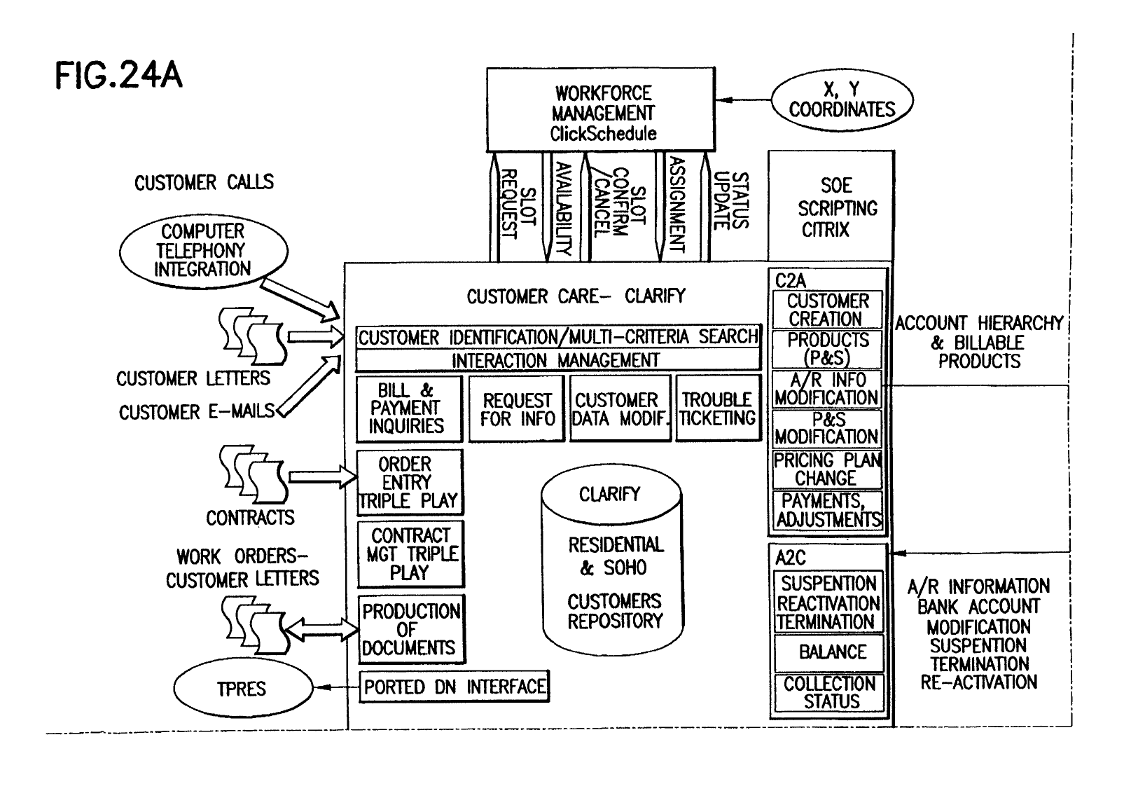

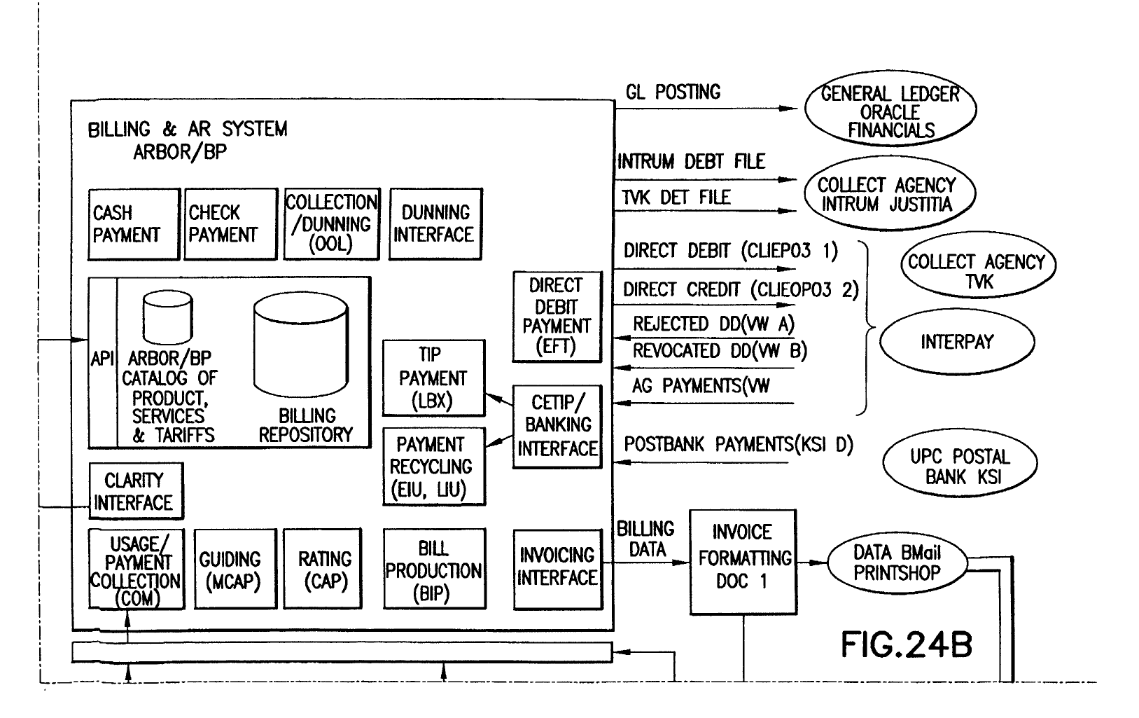

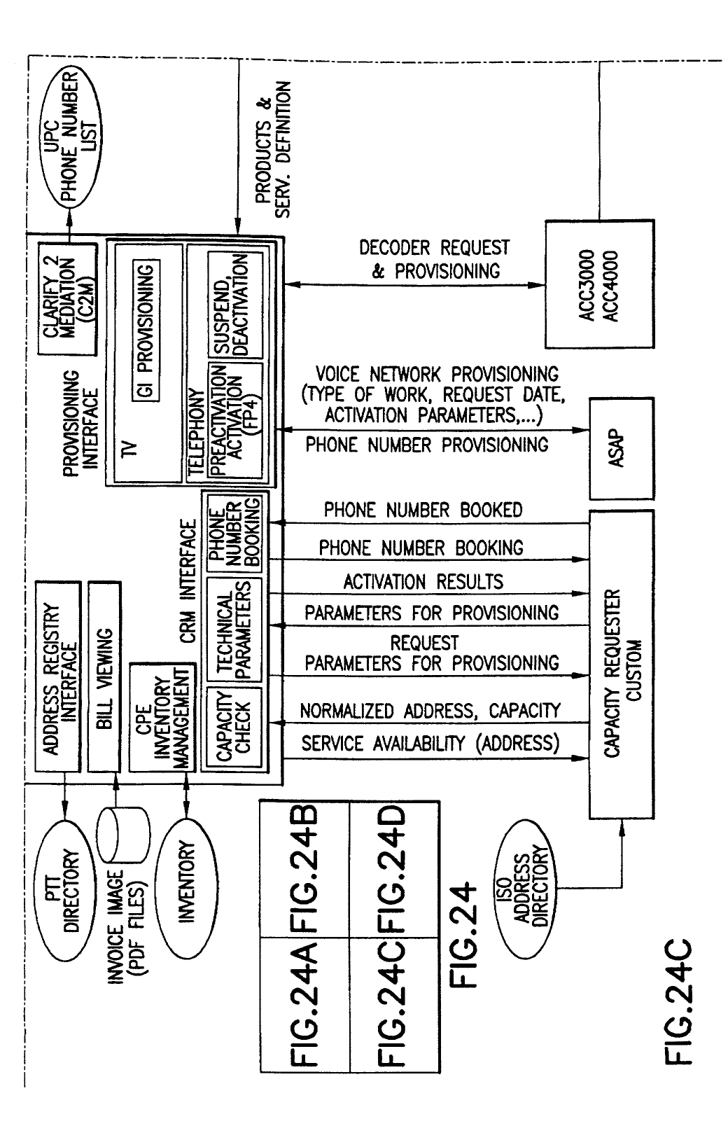

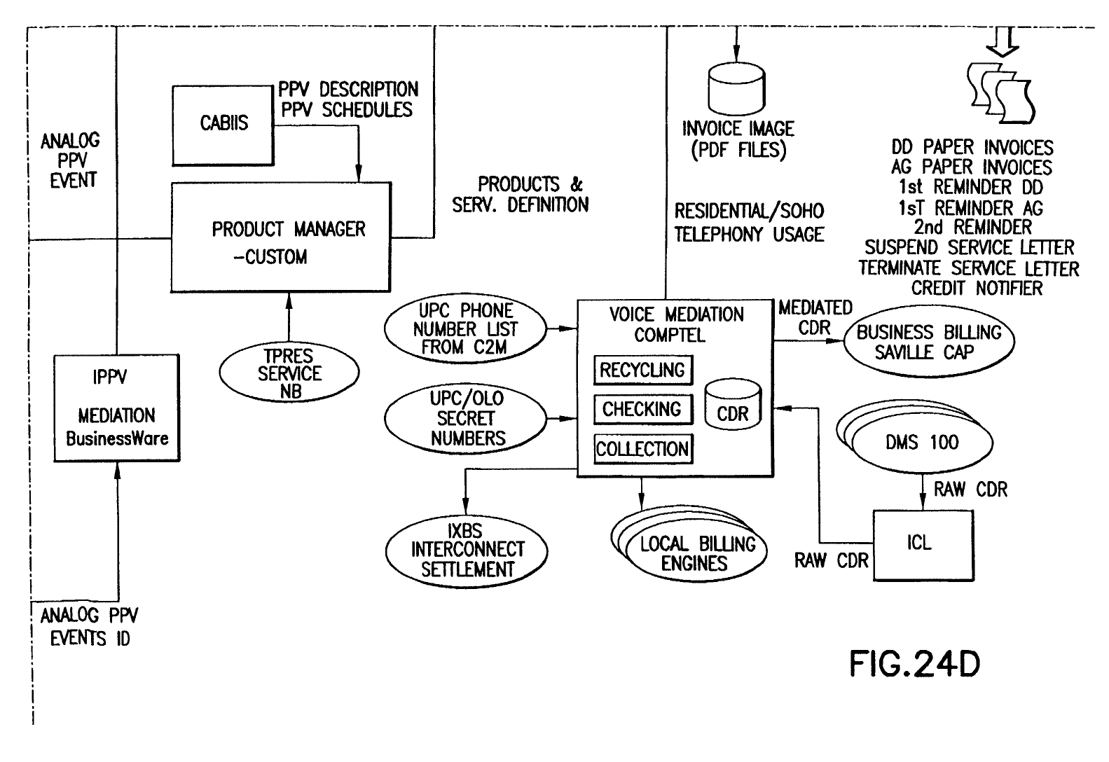

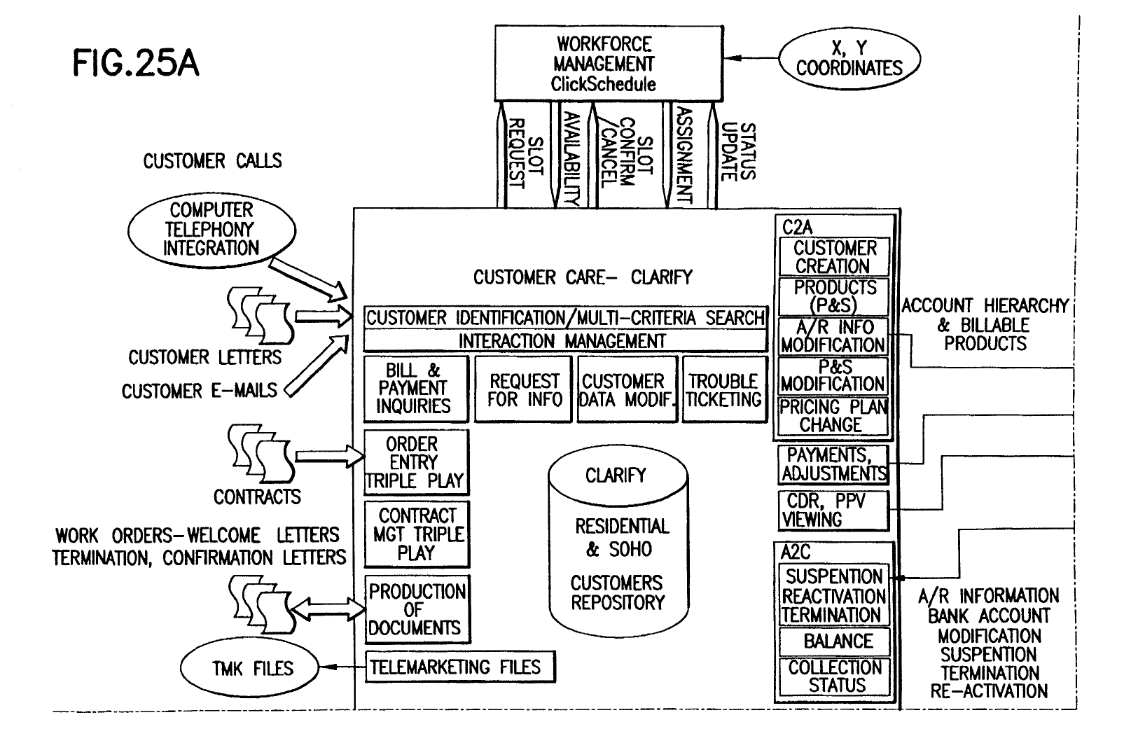

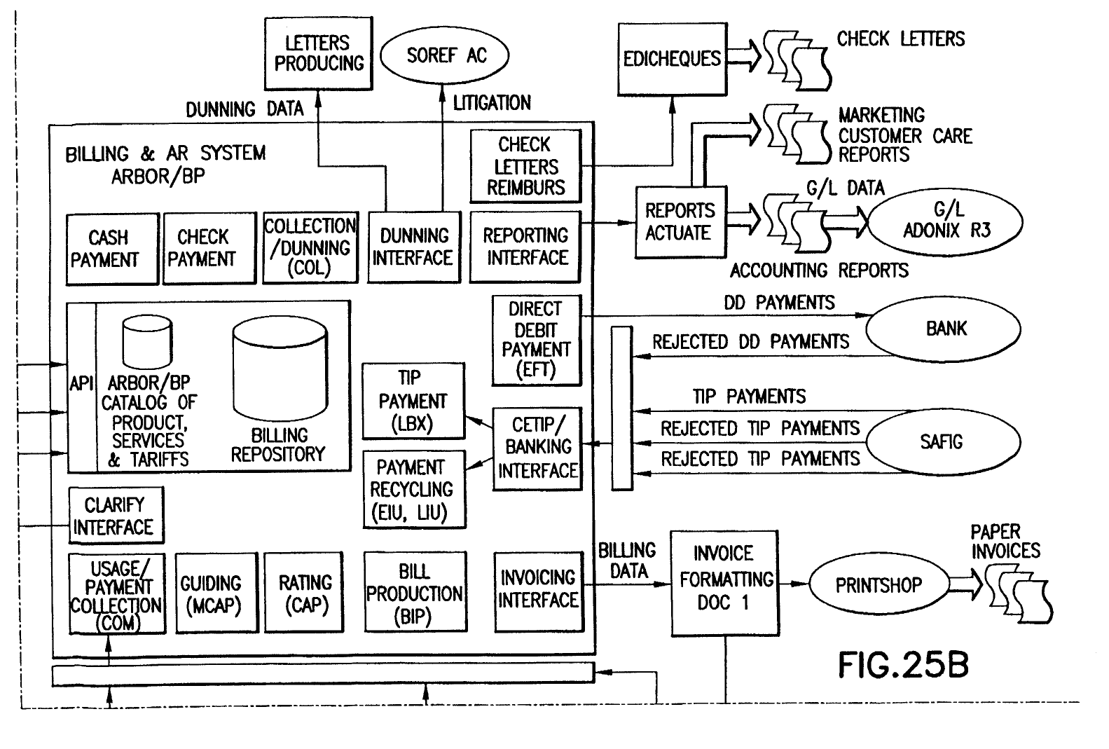

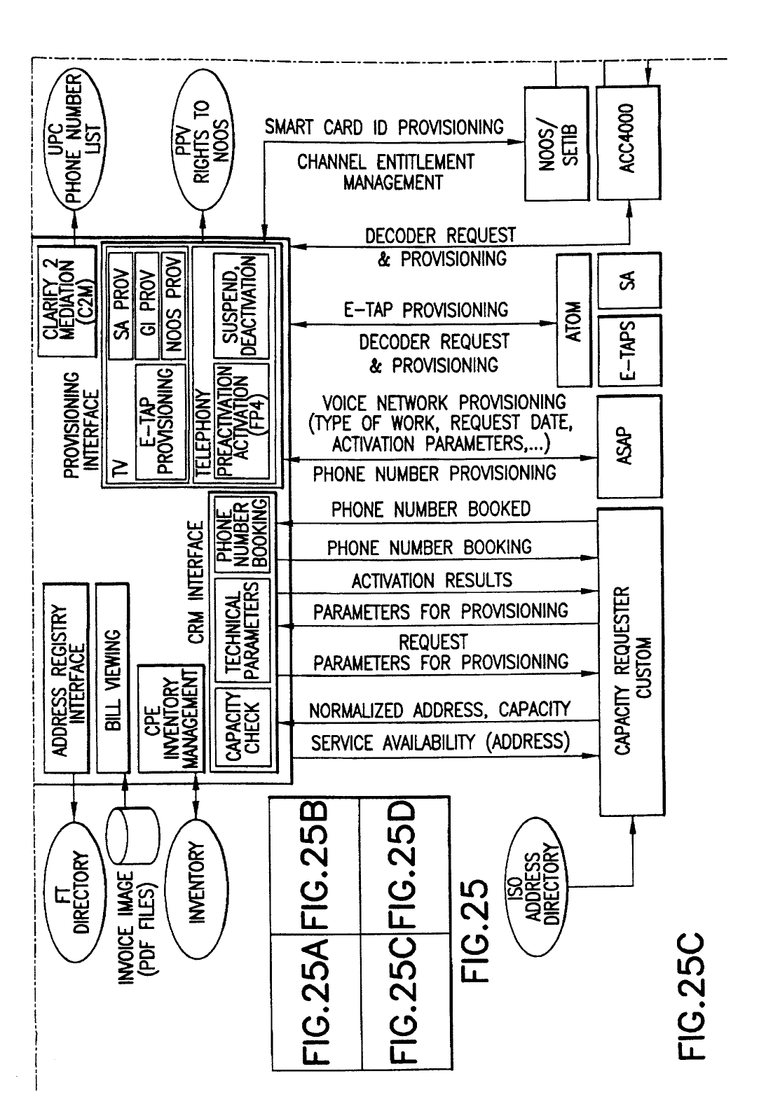

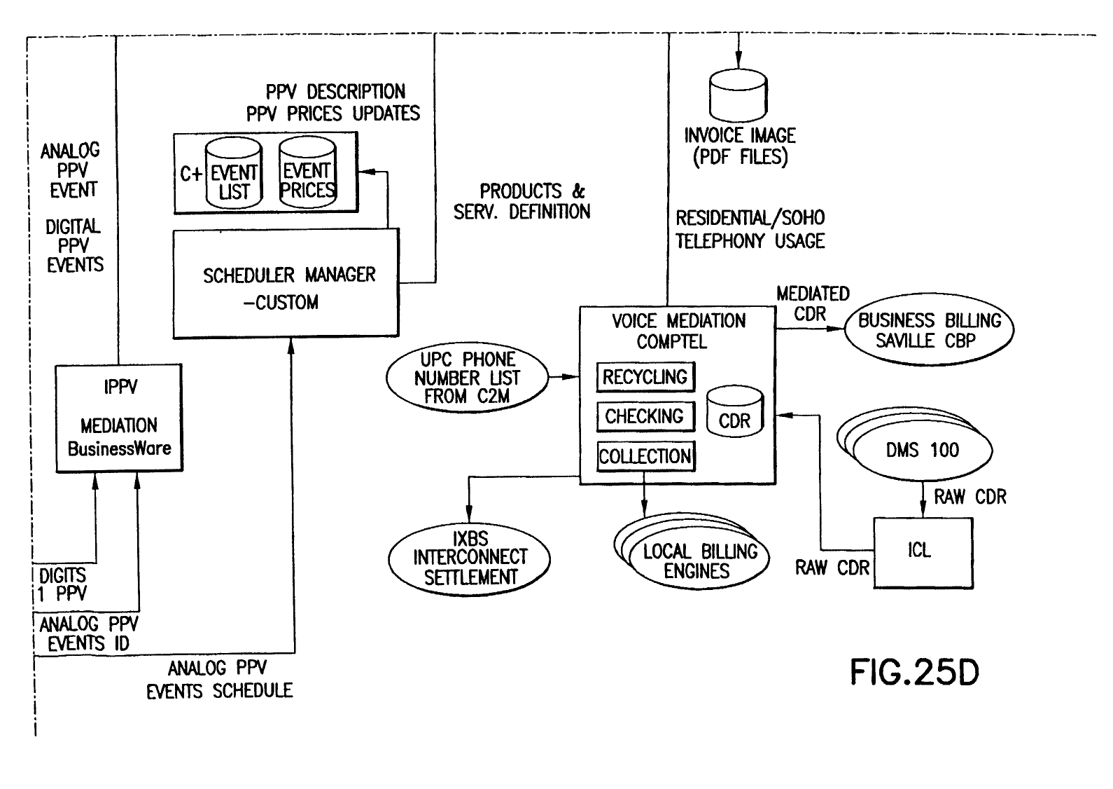

This type of system can provide the sharing of information between the two different companies 612a, 612b. However, in the event the connection(s) 606 fail, the control centers 604 are adapted to operate independently of connection to the main control center 602 or each other. Referring now also to FIGS. 24 and 25, detailed application architectures for two different regional control centers 604 in two different companies 612a, 612b are shown as an example of control centers that can be connected to each other in the system 600 shown in FIG. 23. The two detailed application architectures are merely shown as examples, and should not be interpreted as being limited.

The integrated application suite described above can be configured and reused for addition of another country or application need. To address business specific needs and country constraints, the integrated application suite has been designed to be implemented in a stepwise progression. This allows instances which are completely separate (running on different machines in the data center). Reuse between country implementations is established by copying a solution, which has been implemented for one country, and customizing it for another country, or by sharing the design effort, through a cross country development team organization.

The system as described above can provide a multi service capability which can include upgrading and/or cross selling of services, convergent billing with multiple products, and multi service provisioning. The system can be provided as an integrated system with multichannel sales support, real-time order entry and availability checking, process automation (e.g. automated provisioning), and data integrity and consistency software across packages. The system can be provided as a modular, scalable and cost-efficient system for complex product portfolios combined with high volume requirements, flexibility for revenue tracking and sediment, customer self care front end through IEG and the Internet, can provide country specific requirements, and is scalable through low marginal investment.

The investment made for implementing the system described above can be leveraged by increasing usage through several directions including deployment in new properties (e.g. deployment in the new countries), increasing coverage and current instances (new and migrated areas), and managing more businesses or technical functions (e.g. new services such as VolP). In addition, the system is a very valuable starting point for building a business specific solution, such as business telephony for specific uses.

The overall objective of the present invention is to develop one information technology converged solution that can support different telecommunications business lines and product sets. This includes developing the appropriate information technology systems, infrastructure and end-to-end operations included in the seven families architecture shown in FIG. 7B. The vision for use of this system is to integrate existing systems and processes throughout a region, such as Europe, to meet a supplier's growth and customer service objectives. This system is an end-to-end convergent solutions that supports the execution of a “triple play” strategy. The triple play strategy comprises upgrading and/or cross selling of services, convergent billing with multiple products, and a multi service provisioning in at least three types of telecommunications services including telephone, Internet and television. The system is intended to be composed of a number of different component systems, which support the business processes of the supplier. Implementation of the system can provide customers of the supplier with better service and at a lower cost per customer. More specifically, the objectives can be grouped into the following three categories:

1. to increase throughput capacity: a focus on growing the suppliers customer base;

2. to increase customer satisfaction: a focus on providing better customer service; and

3. to increase efficiency: a focus on improving the

suppliers internal operations.

Numerous systems and databases make system maintenance, and support of growing volumes of data, while guaranteeing performance, difficult. Thus, the present system is designed to provide a modular, integrated and scalable solution to support a complex product portfolio with high volume requirements. Telecommunication suppliers need to be in a position to better follow up activity across the different services, and build a coherent multi-service triple play (telephone, Internet and television) view.

The present invention is intended to support promoting marketing and commercial development of one “global” offer (upgrading/cross selling of services key to achieve a triple play revenue per customer), multi-service provisioning, and convergent billing and heterogeneous pricing schemes (telephone, Internet, DTV, eCommerce). There is a desire to provide better integration and communication between departments of a supplier. The present invention facilitates direct access to all information concerning a client (transparency of data), in real time (e.g. real-time order entry availability checking). The present invention can support multiple sales channels (door-to-door, mail, Telesales, Internet sales, DTV sales, retailers, etc.). The present invention is intended to provide a customer self care front end through IEG and the Internet to maximize business process automation.

The present invention is intended to provide flexibility for revenue tracking and settlement between branding companies, service companies and other third parties. The present invention is intended to facilitate movements from one region to another, and integration of new entrants. The present invention should become common to all departments and products in order to standardize and improve the quality of services across the service provider. Country specific requirements (language, currency, tax, payment, privacy regulation, network technology) can be addressed as efficiently as possible for maintainability; and it should be possible to replicate the present invention across entities and product lines.

It should be noted that the various specific software applications, systems and programs that were mentioned above are exemplary, and are not intended to be construed in a limiting sense upon the practice of this invention, as other software packages, either commercially available or specially written, may be substituted to achieve the same or equivalent system operation.

Thus, while the invention has been particularly shown and described with respect to preferred embodiments thereof, it will be understood by those skilled in the art that changes in form and details may be made therein without departing from the scope and spirit of the invention.

What is claimed is:

1. A business system for providing content and services to customers over an infrastructure, comprising:
a plurality of business application modules and associated databases; and
a bus for interconnecting said plurality of business application modules and said associated databases for providing an inter-application module and message and data translation capability; wherein
at least one of said plurality of business application modules is a customer billing application module that cooperates with others of said plurality of business application modules and with said customer equipment through said bus for generating, for individual ones of said customers, a bill that contains a unified accounting of all of the content and services received by said customer through said infrastructure.

2. A business system as in claim 1, wherein said bus comprises an enterprise application integration (EAI) bus.

3. A business system as in claim 1, wherein said infrastructure is comprised of at least one of coaxial cable, optical fiber and a wireless network.

4. A business system as in claim 1, wherein said content and services comprise all or some of telephony, cable television, interactive television, pay-per-view events, video-on-demand, near video-on-demand, digital television and Internet access.

5. A business system as in claim 2, wherein said EAI bus runs on a plurality of servers, each of which may be capable of independent operation, and that are connected through a data communications network.

6. A business system as in claim 1, wherein individual ones of said customers are provided with said customer equipment that is coupled to said bus through a connector, and wherein said customer equipment is provisioned by one of said business application modules through said bus.

7. A business system as in claim 1, wherein individual ones of said customers are provided with said customer equipment that is coupled to said bus through a connector, and wherein said customer equipment operates to periodically transmit billing-related information through said bus to said customer billing application module.

8. A modular, scalable, end-to-end business method for providing content and services to customers over an infrastructure and for accounting for the use of the content and services by individual ones of the customers, comprising steps of:
providing a business system as a plurality of business application modules and associated databases that are coupled together through an enterprise application integration (EAI) bus, the EAI bus also coupling to customer equipment and further providing an inter-application module and customer equipment messaging function and message and data translation capability;
periodically transmitting billing-related messages through said EAI bus from customer equipment to a customer billing application module, said billing-related messages containing information concerning a customer's usage or ordering of at least one of telephony, cable television, interactive television, pay-per-view events, video-on-demand, near video-on-demand, digital television and Internet access; and
operating the customer billing application module cooperatively with others of the plurality of business application modules and with the customer equipment through the EAI bus for generating, for individual ones of the customers, a bill that contains a unified accounting of all of the content and services received by the customer through the infrastructure.

9. A multi-service telecommunications system comprising:
a telephone service delivery system;
an Internet service delivery system;
a television service delivery system;
a multi-service administration system comprising a sales system, a billing system and a provisioning system, wherein the sales system, the billing system and the provisioning system are adapted to provide sales, billing and provisioning of all three of the telephone, Internet and television service delivery systems through a same enterprise application integration business support system software coupling.

10. A multi-service telecommunications system as in claim 9 wherein the sales system of the multi-service administration system is adapted to provide upgrading and/or cross-selling of services in the telephone, Internet and television service delivery systems.

11. A multi-service telecommunications system as in claim 9 wherein the billing system of the multi-service administration system is adapted to provide convergent billing with multiple products and services of the telephone, Internet and television service delivery systems.

12. A multi-service telecommunications system as in claim 9 wherein the provisioning system of the multi-service administration system is adapted to provide multi-service provisioning of services in the telephone, Internet and television service delivery systems.

13. A multi-service telecommunications system as in claim 12 wherein the provisioning system comprises an automated automatic provisioning system for all three of the telephone, Internet and television service delivery systems.

14. A multi-service telecommunications system as in claim 9 wherein the sales system of the multi-service administration system comprises multi-channel sales support of the telephone, Internet and television service delivery systems.

15. A multi-service telecommunications system as in claim 9 wherein the multi-service administration system comprises an integrated coupling of the sales system and the provisioning system for real-time order entry and availability checking of the telephone, Internet and television service delivery systems.

16. A multi-service telecommunications system as in claim 9 wherein the multi-service administration system comprises an integrated data sharing system among the sales system, billing system and provisioning system.

17. A multi-service telecommunications system as in claim 9 wherein data input into the multi-service administration system for a first one of the service delivery systems is used as common data in the administration system for the other ones of the service delivery systems.

18. A multi-service telecommunications system as in claim 17 wherein the multi-service administration system is adapted to automatically configure the sales system, billing system and provisioning system based upon a country location of a customer.

19. A multi-service telecommunications and administration system comprising:
at least one provisioning system for provisioning at least two different types of telecommunications services;
a customer care module coupled to the at least one provisioning system;
a plurality of back-office modules coupled to the customer care module, the back-office modules comprising a billing and accounts receivable module and a workforce management module,
wherein the customer care system and the back-office modules are adapted to service the at least two different telecommunications services.

20. A multi-service telecommunications and administration system as in claim 19 wherein the at least two different types of telecommunications services comprise services in a telephone service delivery system, an Internet service delivery system, and a television service delivery system.

21. A multi-service telecommunications and administration system as in claim 19 further comprising an enterprise application integration package which operably couples the provisioning system, customer care module, and back-office modules to each other for sharing common data among different software packages in the positioning system, customer care module, and back-office modules.

22. A multi-service telecommunications and administration system as in claim 19 wherein the at least one provisioning system comprises a telephone provisioning system, a television management system, and a capacity requester.

23. A multi-service telecommunications and administration system as in claim 19 wherein the plurality of back-office modules for the comprise a product management module, and the invoice module, and a telephone mediation module.

24. A method of combining at least two telecommunications systems with a common administration system, the at least two telecommunication systems consisting of a group comprising a telephone service delivery system, an Internet service delivery system, and a television service delivery system, the method comprising steps of:
coupling at least two back-office modules of the at least two telecommunications systems through an enterprise application integration package to provide integrated back-office services for customers of the at least two telecommunications systems, the back-office modules comprising at least a billing module;
coupling customer care modules for the at least two telecommunications systems through the enterprise application integration package; and
coupling the customer care modules of the at least two telecommunications systems with the at least two back-office modules of the at least two telecommunications systems through the enterprise application integration package.

25. A method as in claim 24 further comprising sharing data among the modules of the at least two telecommunications systems through the enterprise application integration package.
